(19) United States
(12) Patent Application Publication
(10) Pub. No.: US 2020/0005992 A1
(43) Pub. Date: Jan. 2, 2020

(54) SYSTEM AND METHOD FOR BUILDING ELECTROMAGNETIC COIL STRUCTURES

(71) Applicant: Scott Kreisler, Sugar Hill, GA (US)

(72) Inventor: Scott Kreisler, Sugar Hill, GA (US)

(21) Appl. No.: 16/026,011

(22) Filed: Jul. 2, 2018

(51) Int. Cl. H01F 27/28; H01F 27/24

(52) U.S. Cl. CPC H01F 27/2823; H01F 27/2895; H01F 27/24

(57) ABSTRACT

Implementations of a system and method for building electromagnetic coil structures are provided. In some implementations, the system for building electromagnetic coil structures comprises one or more top parts, bottom parts, hub circles, support rings, adapter rings, base circles, and/or dividers.

In some implementations, the method for building electromagnetic coil structures comprises connecting the one or more top parts, bottom parts, hub circles or adapter rings, and support rings to build an electromagnetic coil structure. In some implementations, the method for building electromagnetic coil structures comprises connecting the one or more base circles and dividers to build an electromagnetic coil structure, and in some implementations further comprises connecting the one or more support rings and/or hub circles to build the electromagnetic coil structure.

### TECHNICAL FIELD

This disclosure relates to implementations of a system and method for building electromagnetic coil structures.

### BACKGROUND

Coil structures can be used to build electromagnetic coils. The electromagnetic coils are used for electrical generation or various other applications involving electromagnetic fields. Most such coil structures consist of simple shaped solid or hollow components such as a solid iron ring or a hollow plastic ring, as shown in FIGS. 1 and 2 respectively. As a result, there is a limit to building complex electromagnetic coils using such coil structures. However, a build set does not exist for building more complex coil structures for such coils.

### BRIEF DESCRIPTION OF THE DRAWINGS

FIG. 1 illustrates an existing example of an electromagnetic coil built on a solid iron ring coil structure.

FIG. 2 illustrates an existing example of an electromagnetic coil built on a hollow plastic ring coil structure.

FIGS. 3A-3C illustrate implementations of example complex electromagnetic coils built on example complex electromagnetic coil structures according to the present disclosure.

FIGS. 4A-4C illustrate implementations of an example top part and bottom part according to the present disclosure.

FIGS. 5A and 5B illustrate implementations of example hub circles and hubs according to the present disclosure.

FIG. 6 illustrates implementations of example support rings according to the present disclosure.

FIG. 7 illustrates implementations of example adapter rings according to the present disclosure.

FIGS. 8A-8C illustrate implementations of example base circles and a base according to the present disclosure.

FIG. 8D illustrates example parameters of the base circles shown in FIGS. 8A-8C.

FIGS. 9A-9F illustrate implementations of example dividers according to the present disclosure.

FIG. 9G illustrates example parameters of the dividers shown in FIGS. 9A-9F.

FIG. 10 illustrates an example representation of toroidal shaped electromagnetic coils that can be built on electromagnetic coil structures according to the present disclosure.

FIGS. 11A-11C illustrate example representations of a unit size of the parts of electromagnetic coil structures according to the present disclosure.

FIG. 12 illustrates an example representation of a design of a top part or a bottom part for building electromagnetic coil structures according to the present disclosure.

FIG. 13 illustrates an implementation of an example main row of a top part or a bottom part for building electromagnetic coil structures according to the present disclosure.

FIGS. 14A and 14B illustrate implementations of an example pre-final form of a top part and a bottom part for building electromagnetic coil structures according to the present disclosure.

FIGS. 15A and 15B illustrate other implementations of an example pre-final form of a top part and a bottom part for building electromagnetic coil structures according to the present disclosure.

FIGS. 16A and 16B illustrate implementations of an example final form of a top part and a bottom part for building electromagnetic coil structures according to the present disclosure.

FIGS. 16C-16F illustrate examples of the final form of the top part and the bottom part shown in FIGS. 16A and 16B connected together for building electromagnetic coil structures according to the present disclosure.

FIGS. 16G and 16H illustrate example parameters of the final form of the top part and the bottom part shown in FIGS. 16A and 16B.

FIG. 16I illustrates another implementation of an example final form of a bottom part for building electromagnetic coil structures according to the present disclosure.

FIGS. 17A and 17B illustrate implementations of example pre-final form parts and corresponding final form parts with varying P-values for building electromagnetic coil structures according to the present disclosure.

FIG. 18 illustrates an example representation of an incrementally size-increased design for a top part or a bottom part for building electromagnetic coil structures according to the present disclosure.

FIGS. 19A-19E illustrate implementations of example hub circles according to the present disclosure.

FIGS. 19F and 19G illustrate implementations of example electromagnetic coil structures that include hubs according to the present disclosure.

FIG. 19H illustrates example parameters of the hub circles shown in FIGS. 19A-19E.

FIG. 20A illustrates an implementation of an example support ring according to the present disclosure.

FIG. 20B illustrates an implementation of an example electromagnetic coil structure that includes a support ring according to the present disclosure.

FIG. 20C illustrates an implementation of an example electromagnetic coil structure that includes support wire according to the present disclosure.

FIG. 20D illustrates example parameters of the support ring shown in FIG. 20A.

FIGS. 21A-21E illustrate implementations of example adapter rings according to the present disclosure.

FIG. 21F illustrates an implementation of an example electromagnetic coil structure that includes adapter rings according to the present disclosure.

FIG. 21G illustrates example parameters of the adapter rings shown in FIGS. 21A-21E.

FIGS. 22A and 22B illustrate implementations of example parts modified for use with adapter rings according to the present disclosure.

FIGS. 23A and 23B illustrate implementations of example customized parts and an example coplanar multi-coil electromagnetic coil structure built with the customized parts according to the present disclosure.

FIG. 24 illustrates an implementation of an example multi-axis electromagnetic coil structure built with customized parts according to the present disclosure.

### DETAILED DESCRIPTION

Implementations of a system and method for building electromagnetic coil structures are provided. In some implementations, the system for building electromagnetic coil structures comprises one or more top parts, bottom parts, hub circles, support rings, adapter rings, base circles, and/or dividers.

In some implementations, the method for building electromagnetic coil structures comprises connecting the one or more top parts, bottom parts, hub circles or adapter rings, and support rings to build an electromagnetic coil structure. In some implementations, the method for building electromagnetic coil structures comprises connecting the one or more base circles and dividers to build an electromagnetic coil structure, and in some implementations further comprises connecting the one or more support rings and/or hub circles to build the electromagnetic coil structure.

In some implementations, the system and method for building electromagnetic coil structures allows a user to build simple to complex electromagnetic coil structures. In some implementations, the electromagnetic coil structures can be used to build electromagnetic coils that can be used for generating electricity. In some implementations, the electromagnetic coil structures can be used to build electromagnetic coils that can be used for various other applications involving electromagnetic fields.

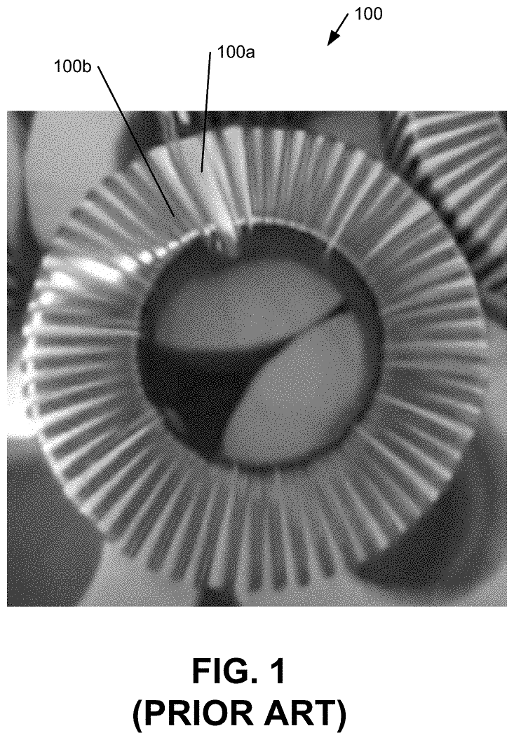

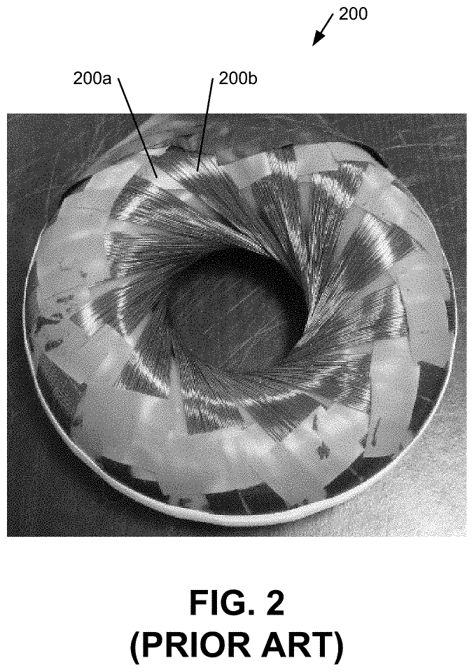

FIG. 1 illustrates an existing example of an electromagnetic coil 100 built on a solid iron ring coil structure 100a. FIG. 2 illustrates an existing example of an electromagnetic coil 200 built on a hollow plastic ring coil structure 200a. As shown, the electromagnetic coil 100, 200 is built with magnet wire 100b, 200b wound over the coil structure 100a, 200a. The electromagnetic coil 100, 200 can produce electricity when a magnetic field is applied to the electromagnetic coil 100, 200. The electromagnetic coil 100, 200 can produce a magnetic field when electricity is applied to the electromagnetic coil 100, 200. The size and/or number of wraps of magnet wire 100b, 200b wound over the coil structure 100a, 200a can vary such electromagnetic capabilities of the electromagnetic coil 100, 200. The configuration of the coil structure 100a, 200a and/or the wraps of magnet wire 100b, 200b on the coil structure 100a, 200a can also vary such electromagnetic capabilities of the electromagnetic coil 100, 200.

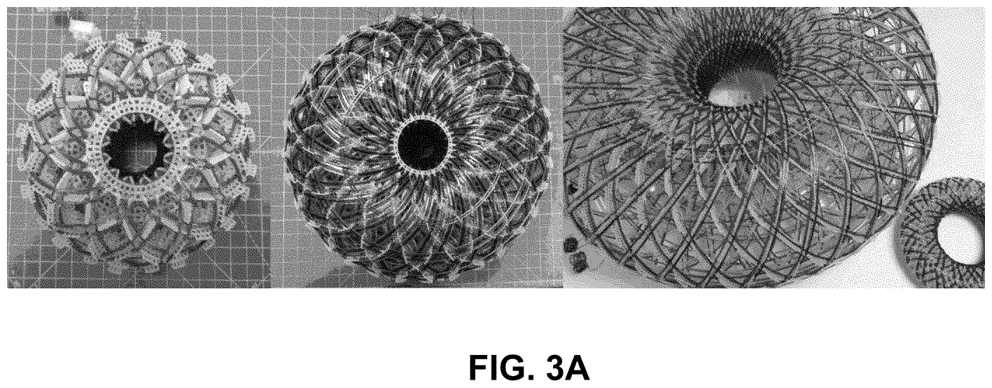

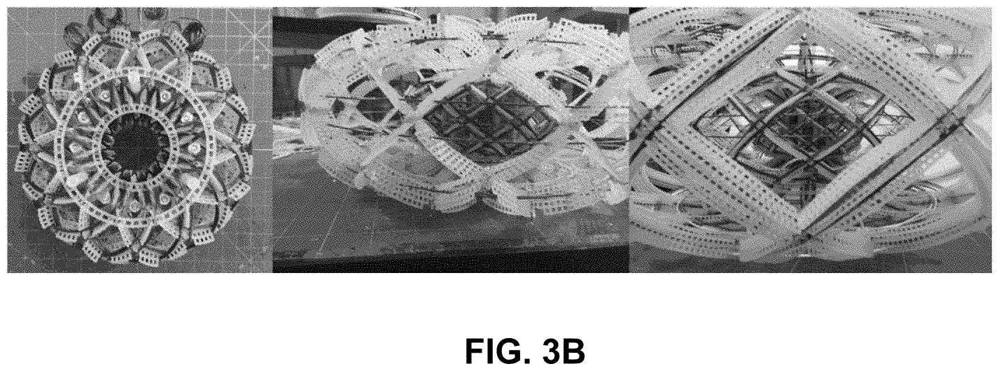

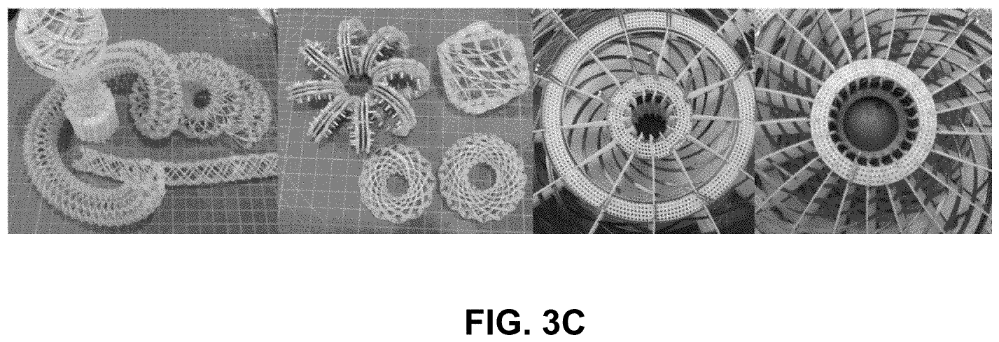

In some implementations, the system and method for building electromagnetic coil structures allows a user to build much more complex electromagnetic coils having much more complex, desirable electromagnetic capabilities than with existing coil structures such as the above-described coil structures 100a, 200a shown in FIGS. 1 and 2. FIGS. 3A-3C illustrate implementations of example complex electromagnetic coils built on example complex electromagnetic coil structures according to the present disclosure. As shown, in some implementations, the electromagnetic coils and corresponding coil structures can vary in size from small to large. In some implementations, the electromagnetic coils and corresponding coil structures can be single-shelled or multi-shelled. In some implementations, the electromagnetic coils and corresponding coil structures can have numerous imaginative designs.

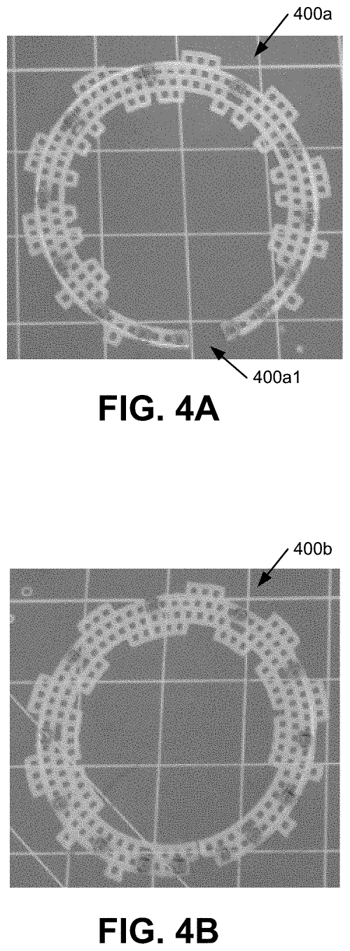

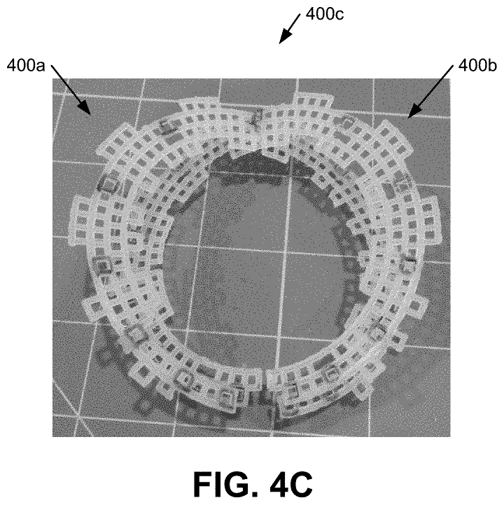

In some implementations, the system for building electromagnetic coil structures comprises a plurality of parts (sometimes referred to below as “parts”) configured to build electromagnetic coil structures. As discussed above, in some implementations, the plurality of parts comprises one or more top parts, bottom parts, hub circles, support rings, adapter rings, base circles, and/or dividers. FIGS. 4A-4C illustrate implementations of an example top part 400a and bottom part 400b according to the present disclosure. In some implementations, as discussed further below, the top part 400a shown in FIG. 4A and the bottom part 400b shown in FIG. 4B are configured to connect together as shown in FIG. 4C.

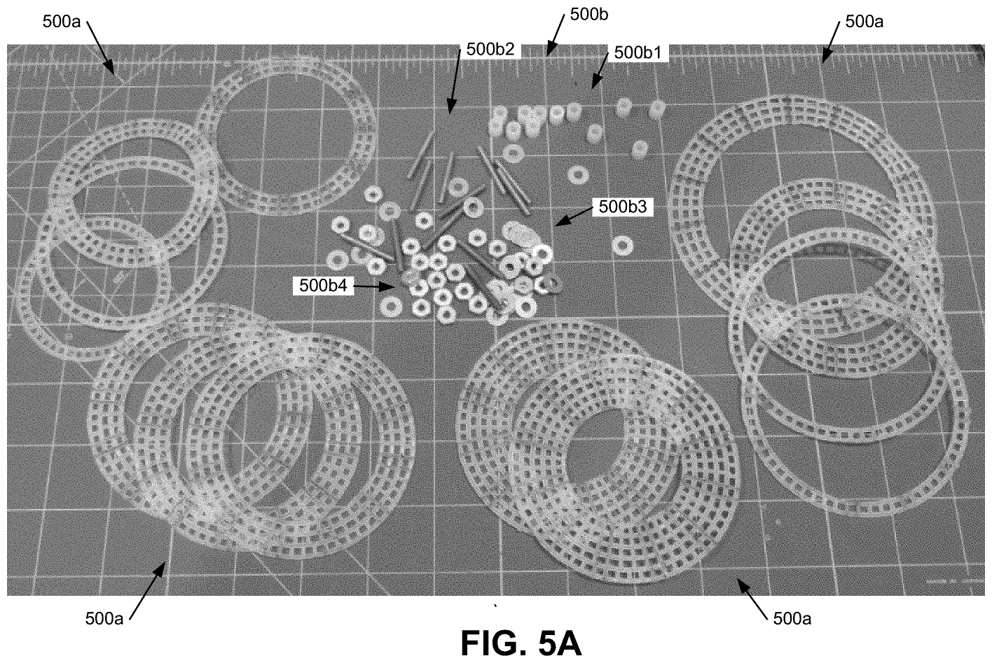

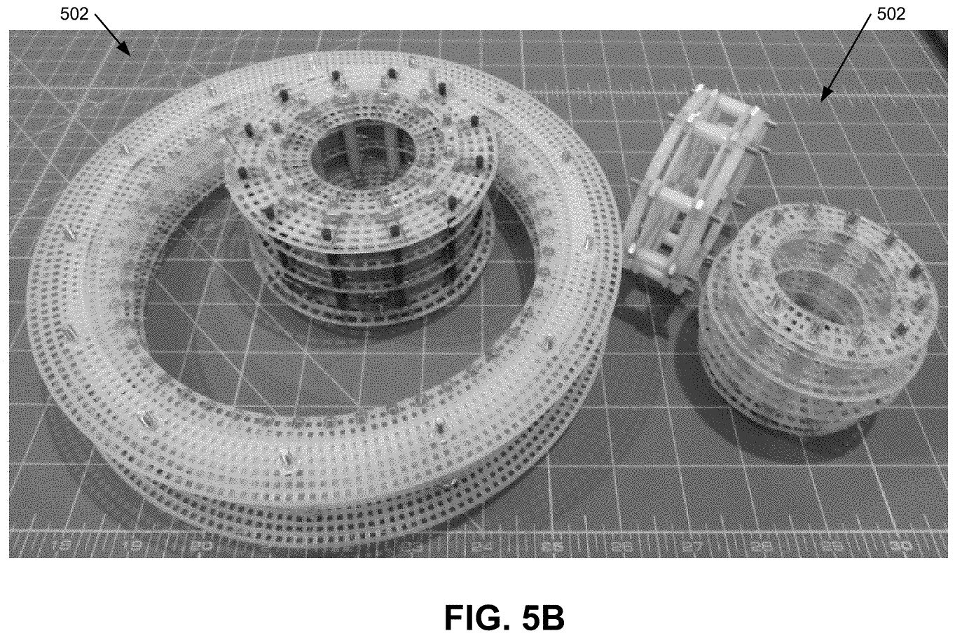

FIGS. 5A and 5B illustrate implementations of example hub circles 500a and hubs 502 according to the present disclosure. In some implementations, as discussed further below, the hub circles 500a shown in FIG. 5A are configured so that one or more of the hub circles 500a along with one or more hub parts 500b shown in FIG. 5A can form hubs 502 shown in FIG. 5B.

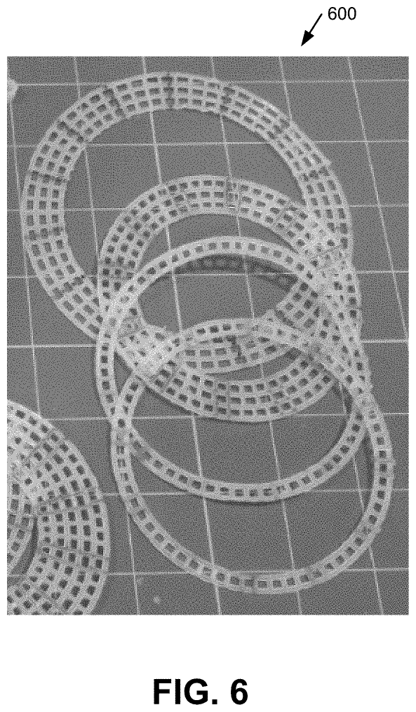

FIG. 6 illustrates implementations of example support rings 600 according to the present disclosure. In some implementations, as discussed further below, the support rings 600 are similar in structure to the hub circles 500a of FIG. 5A.

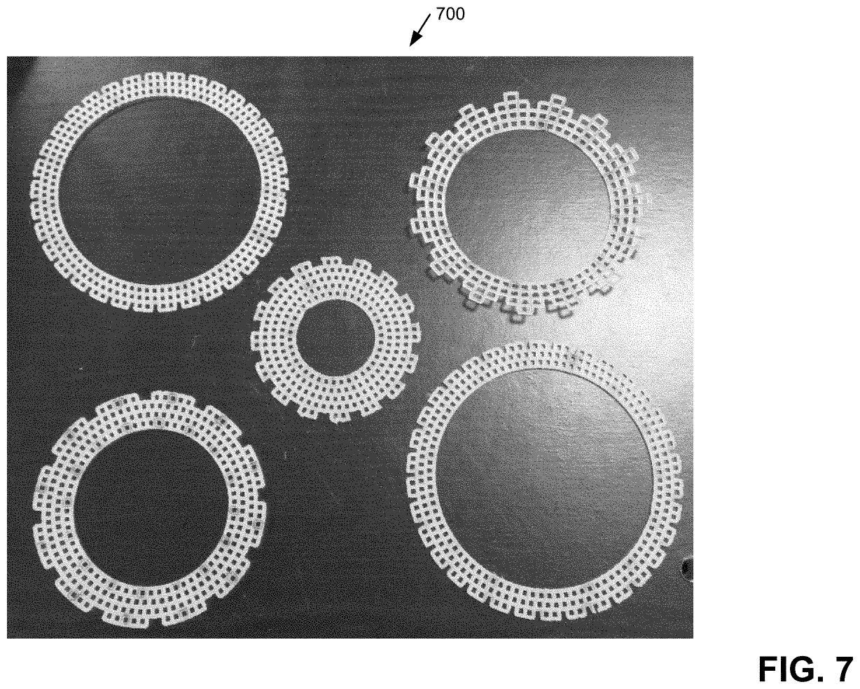

FIG. 7 illustrates implementations of example adapter rings 700 according to the present disclosure. In some implementations, as discussed further below, the adapter rings 700 are similar in structure to the hub circle 500a of FIG. 5A and the support ring 600 of FIG. 6.

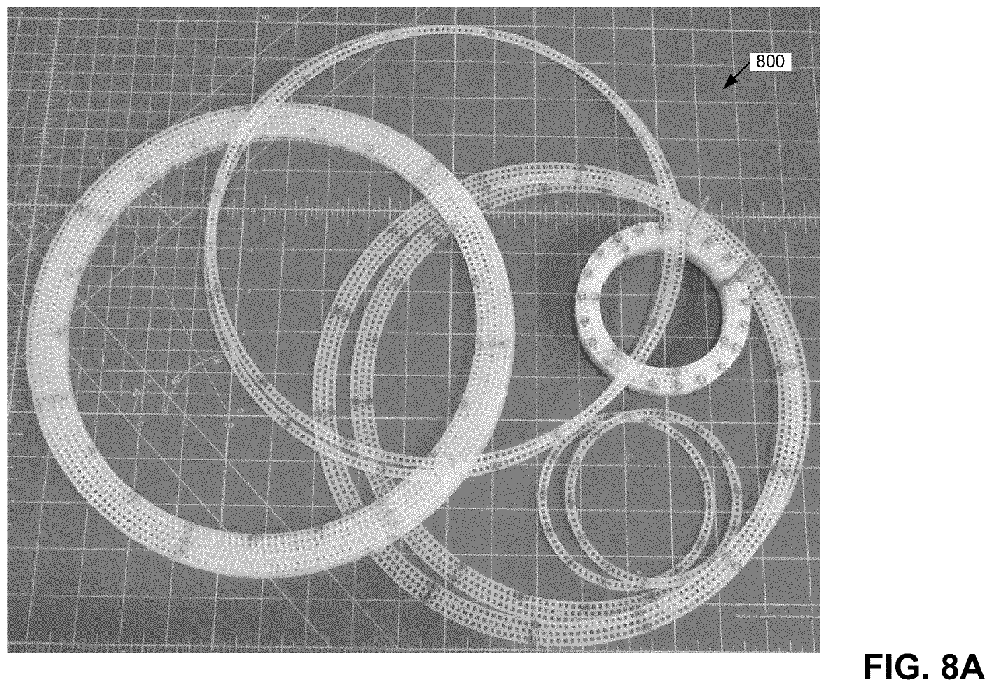

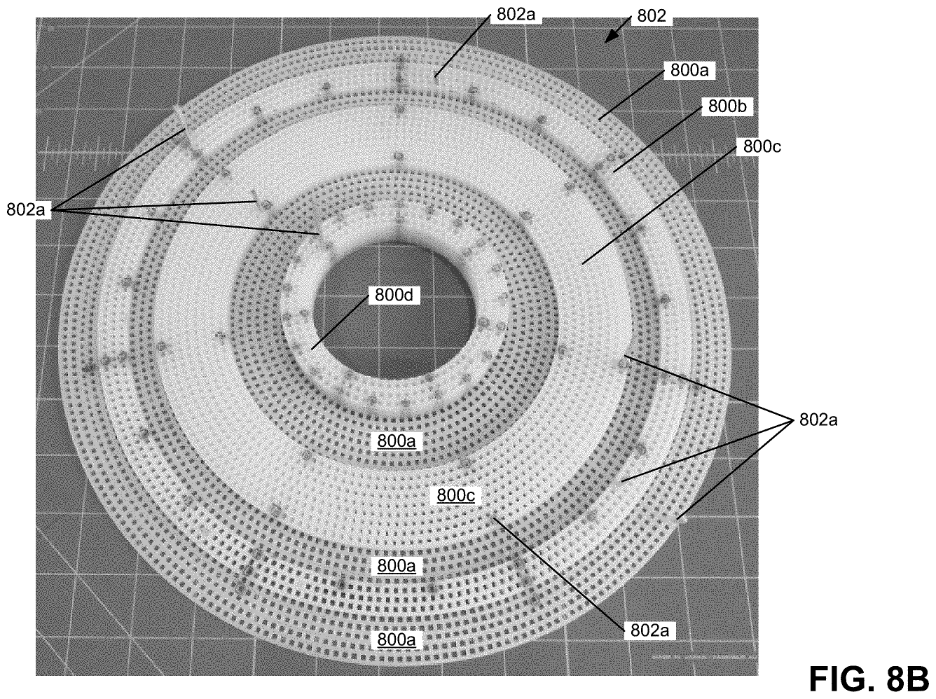

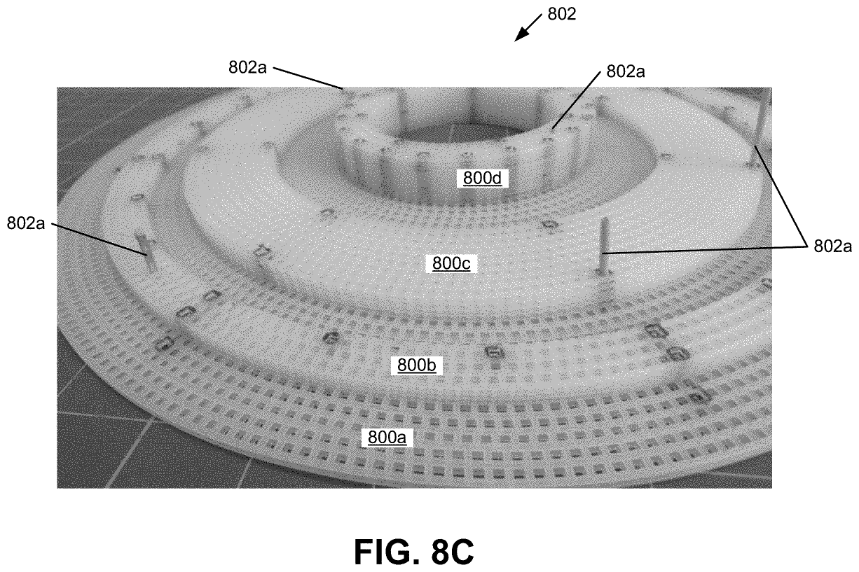

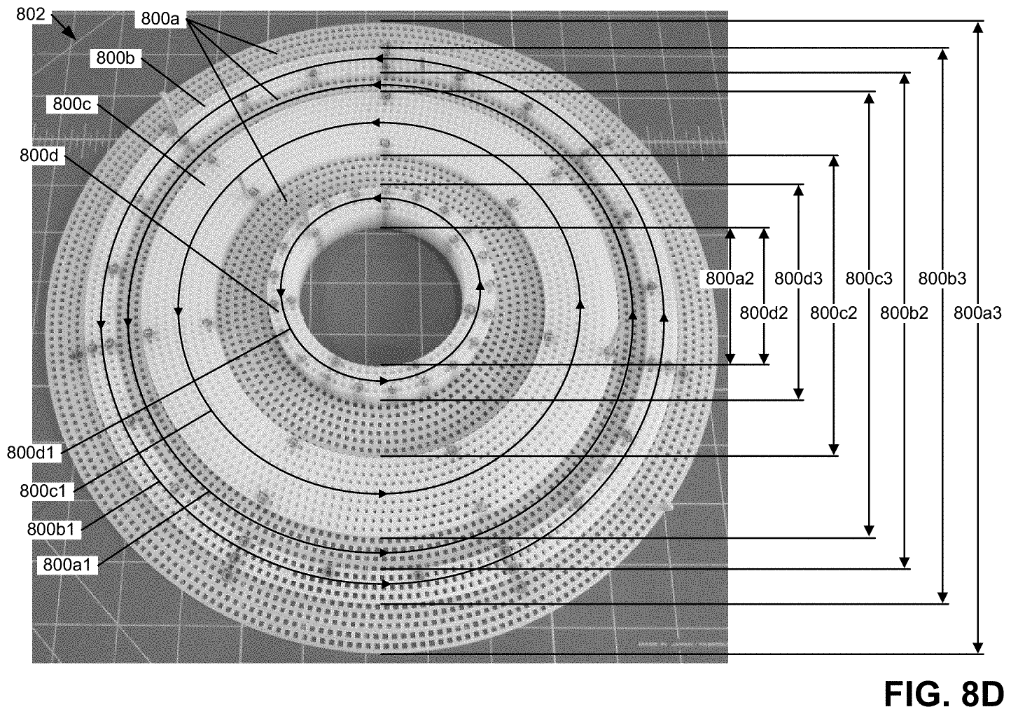

FIGS. 8A-8C illustrate implementations of example base circles 800 and a base 802 according to the present disclosure. In some implementations, as discussed further below, the base circles 800 shown in FIG. 8A are configured to arrange to form a base such as the base 802 shown in FIGS. 8B and 8C. In some implementations, as discussed further below, the base circles 800 are similar in structure to the hub circles 500a of FIG. 5A.

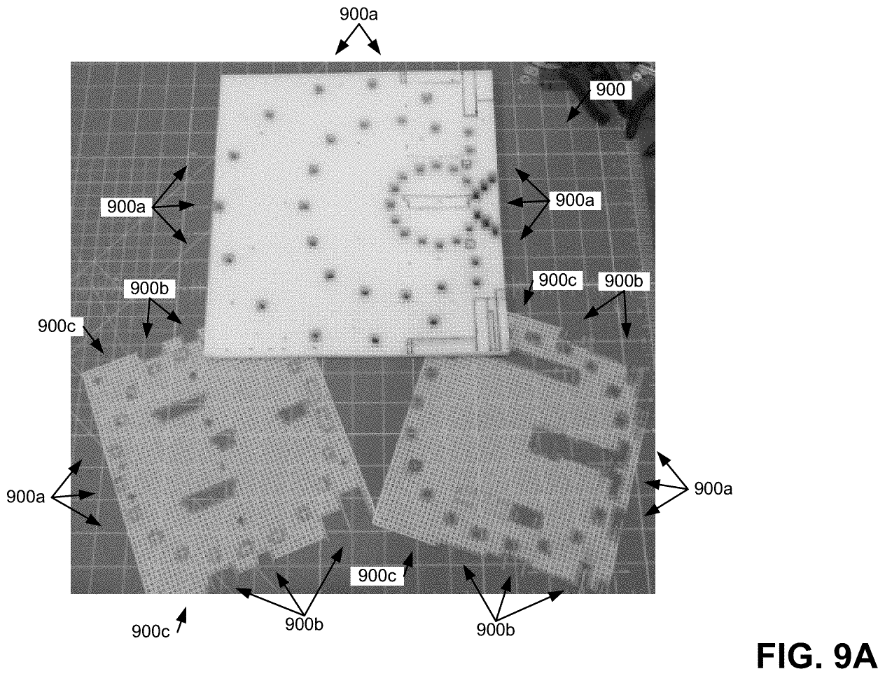

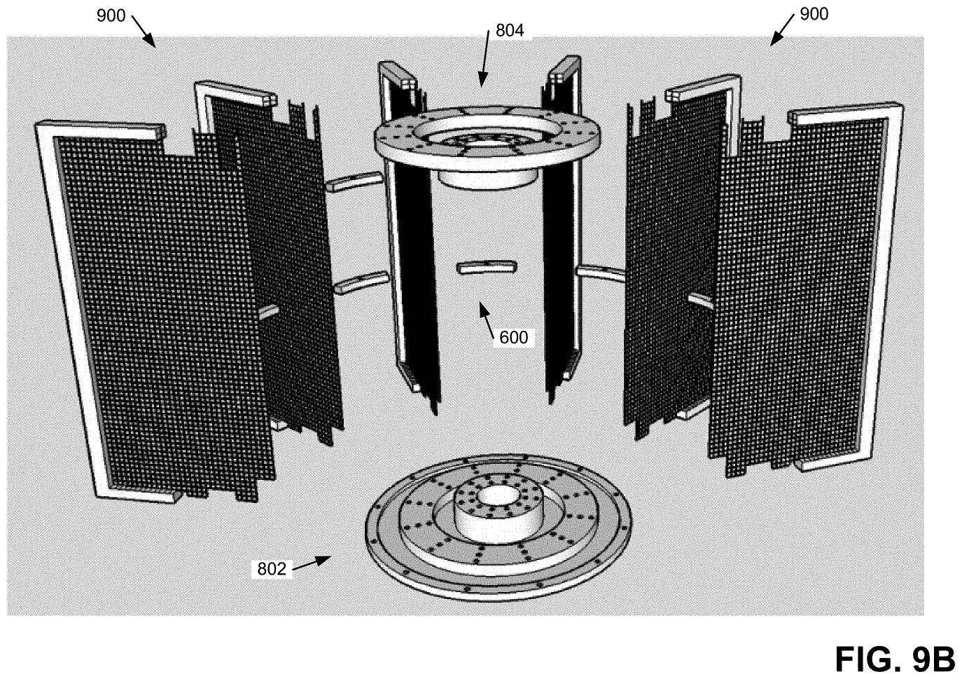

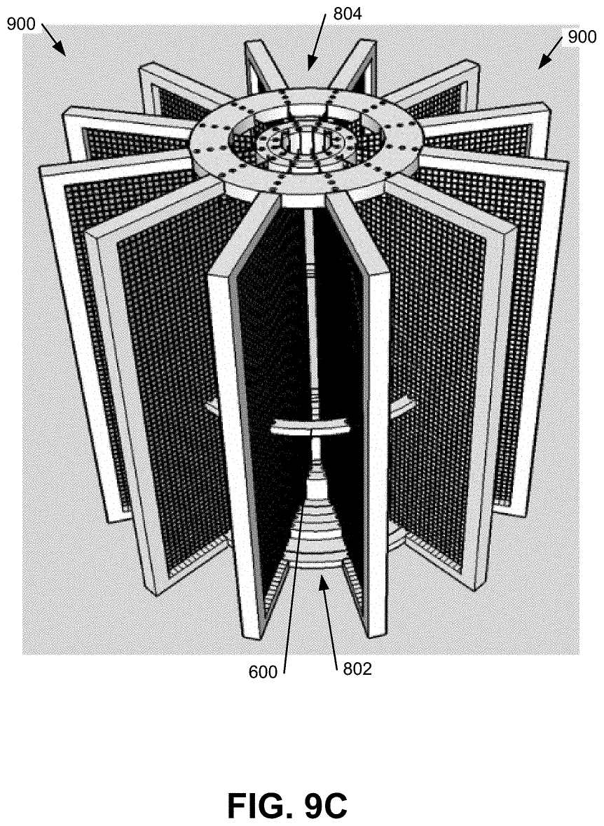

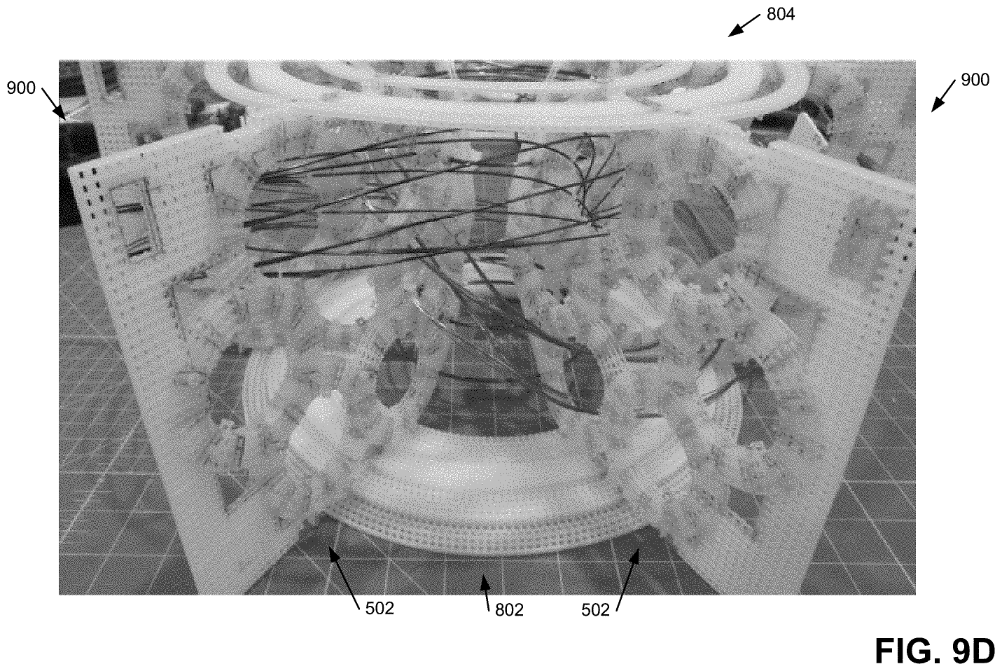

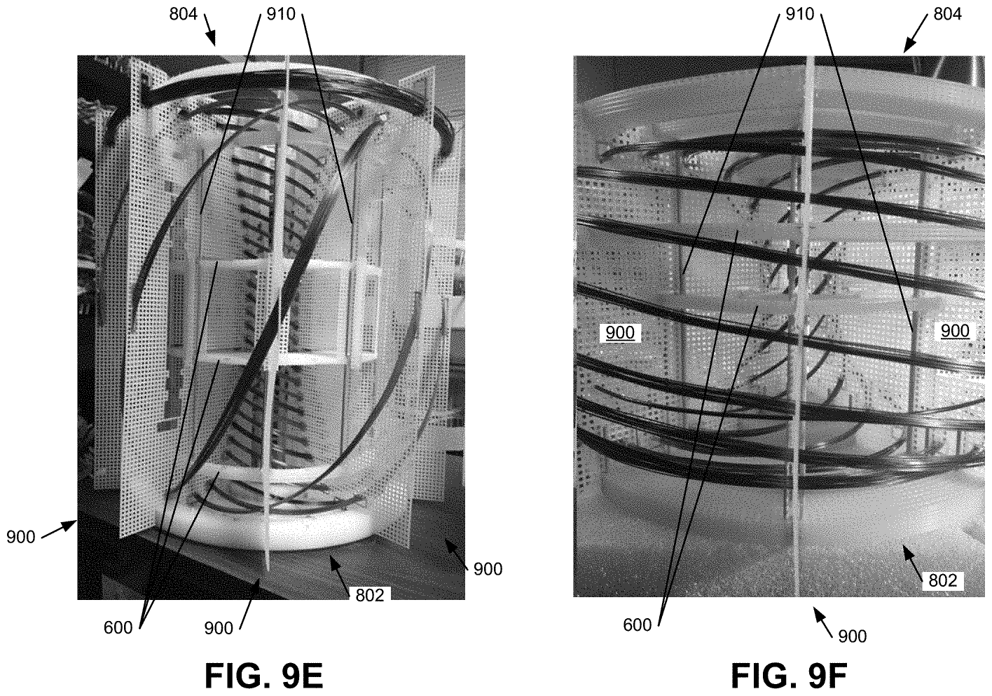

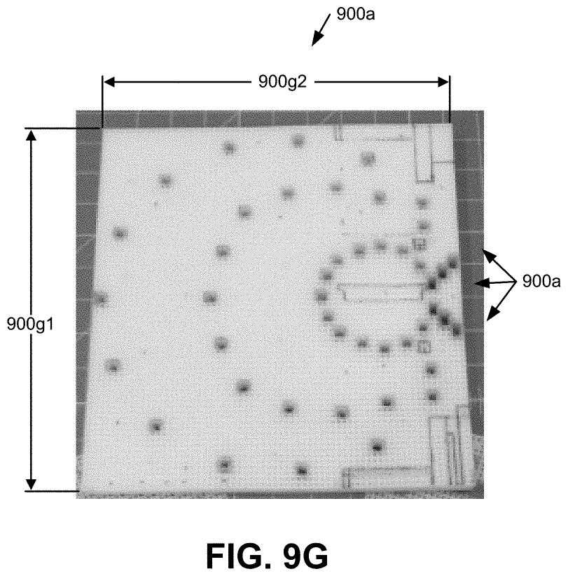

FIGS. 9A-9F illustrate implementations of example dividers 900 according to the present disclosure. In some implementations, as discussed further below, the dividers 900 shown in FIG. 9A are configured to be combined with other parts as shown in FIGS. 9B-9F such as the base 802 of FIGS. 8B and 8C, the support rings 600 of FIG. 6, and the hubs 502 of FIG. 5B.

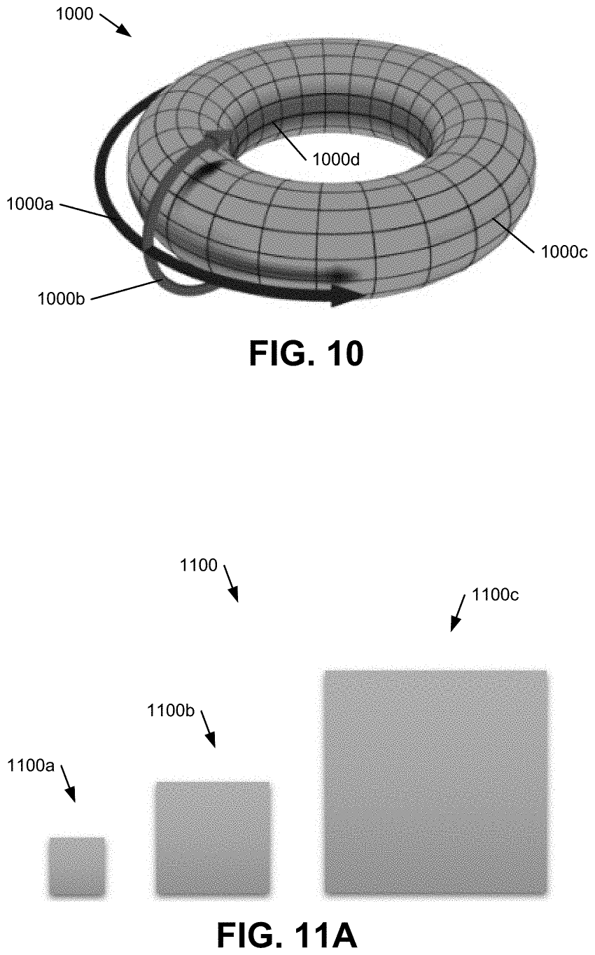

In some implementations, the system and method for building electromagnetic coil structures allows a user to build electromagnetic coil structures for building toroidal shaped electromagnetic coils or “toroidal shaped electromagnetic coil structures”. FIG. 10 illustrates an example representation of toroidal shaped electromagnetic coils 1000 that can be built on electromagnetic coil structures according to the present disclosure. In some implementations, the toroidal shaped electromagnetic coils structures comprise a T-value that represents the outer or major circumference 1000a of corresponding toroidal shaped electromagnetic coils 1000. In some implementations, the toroidal shaped electromagnetic coil structures 1000 comprise a P-value that represents the height or minor circumference 1000b of the corresponding toroidal shaped electromagnetic coils 1000. In some implementations, the toroidal shaped electromagnetic coils 1000 also comprise an outer equator 1000c and an inner equator 1000d. In some implementations, the outer equator 1000c and the inner equator 1000d represent orientation positions on corresponding electromagnetic coil structures built according to the present disclosure as discussed further below.

In some implementations, as discussed further below, toroidal shaped electromagnetic coil structures built according to the present disclosure are described by a T-value and P-value that correspond to the electromagnetic coils 1000 that can be built on the toroidal shaped electromagnetic coil structures. In some implementations, the toroidal shaped electromagnetic coil structures are described in a format of “aT:bP”, “at:bp”, or “a:b”, where “a” and “b” are positive integer constants of appropriate values that represent the T-value and the P-value respectively. For example, in some implementations, a toroidal shaped electromagnetic coil structure with a T-value of twelve (12) and a P-value of seven (7) may be described as a “12T:7P”, “12t:7p”, or “12:7” electromagnetic coil structure.

In some implementations, as discussed further below, the parts for building toroidal shaped electromagnetic coil structures according to the present disclosure are also described by a corresponding T-value and/or P-value. For example, in some implementations, the parts may be described as “12T”, “7P”, or “12T:7P” parts depending on the correspondence of the parts to the T-value and/or P-value of the electromagnetic coil structures to be built.

In some implementations, the parts used to build electromagnetic coil structures having a T-value that is greater than the P-value, such as shown in FIGS. 3A and 3B, comprise one or more of the top part 400a, bottom part 400b, hub 502 (comprised of hub circles 500a) or adapter ring 700 (for using a coil structure as a hub), and support ring 600, as discussed further below.

In some implementations, the parts used to build electromagnetic coil structures having a P-value that is greater than the T-value, such as shown in FIGS. 9D-9F, comprise one or more of the base 802 (comprised of base circles 800), divider 900, and top hub 804 (also comprised of base circles 800), and in some implementations further comprise one or more of the support ring 600 and/or hub 502 (comprised of hub circles 500a), as discussed further below.

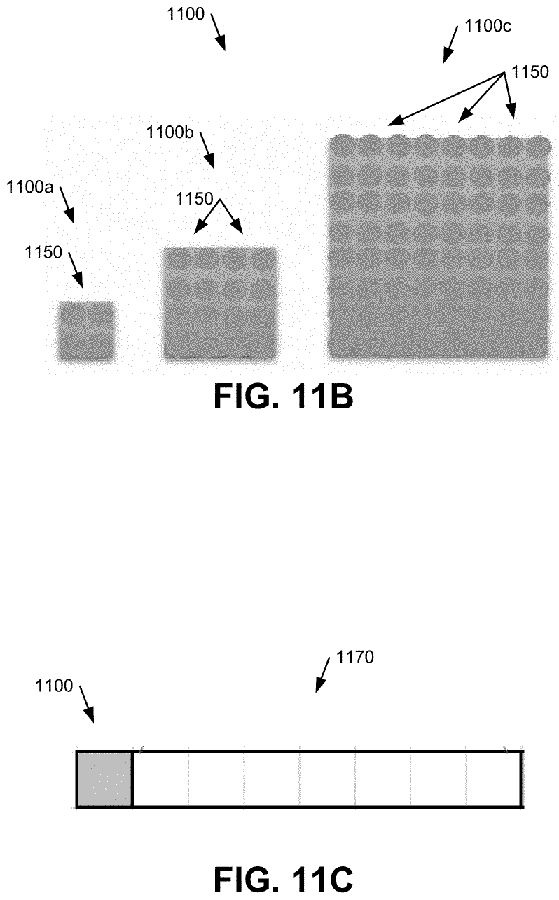

In some implementations, the shape configuration of the parts of the system for building electromagnetic coil structures is based on a unit size of the parts. FIGS. 11A-11C illustrate example representations of a unit size 1100 of the parts of electromagnetic coil structures according to the present disclosure. In some implementations, the unit size of the parts is the size of each of the spaces or units 1100 in the parts. For example, as shown in FIGS. 11A and 11B, in some implementations, the units 1100a, 1100b, 1100c in the parts can vary in size.

In some implementations, the units 1100 are cell-like openings in the parts. In some implementations, the units 1100 are solid or filled spaces in the parts. In some implementations, the units 1100 are square-shaped. In some implementations, the units 1100 can be circular-shaped or any other suitable shape. In some implementations, the units 1100 are configured to hold within or receive therethrough one or more wraps of magnet wire 1150 for building an electromagnetic coil. In some implementations, the unit size of the parts is based on the size and number of wraps of magnet wire 1150 to be used for building an electromagnetic coil. For example, in some implementations, a square-shaped unit 1100 with a unit size of one-sixteenth of an inch ( 1/16″) by one-sixteenth of an inch ( 1/16″) may hold up to nine (9) wraps of 24-gauge magnet wire or up to five (5) wraps of 21-gauge magnet wire.

In some implementations, for parts that are configured based on the P-value, the unit size of such parts is based on the size and number of wraps of magnet wire to be used for building an electromagnetic coil. In some implementations, for parts that are configured based on the T-value, the unit size of such parts is based on the thickness of the material from which such parts are to be built to allow for connecting such parts together or to other parts.

In some implementations, the units 1100 are a per-unit measurement representation of one or more dimensions of the parts. For example, as shown in FIG. 11C, in some implementations, the length and width dimensions of a representative part 1170 comprise one or more units 1100. For example, in some implementations, for a unit size of one-sixteenth of an inch ( 1/16″) by one-sixteenth of an inch ( 1/16″) (or 1/16″ square), the representative part 1170 has a length of eight-sixteenths of an inch ( 8/16″) and a width of one-sixteenth of an inch ( 1/16″).

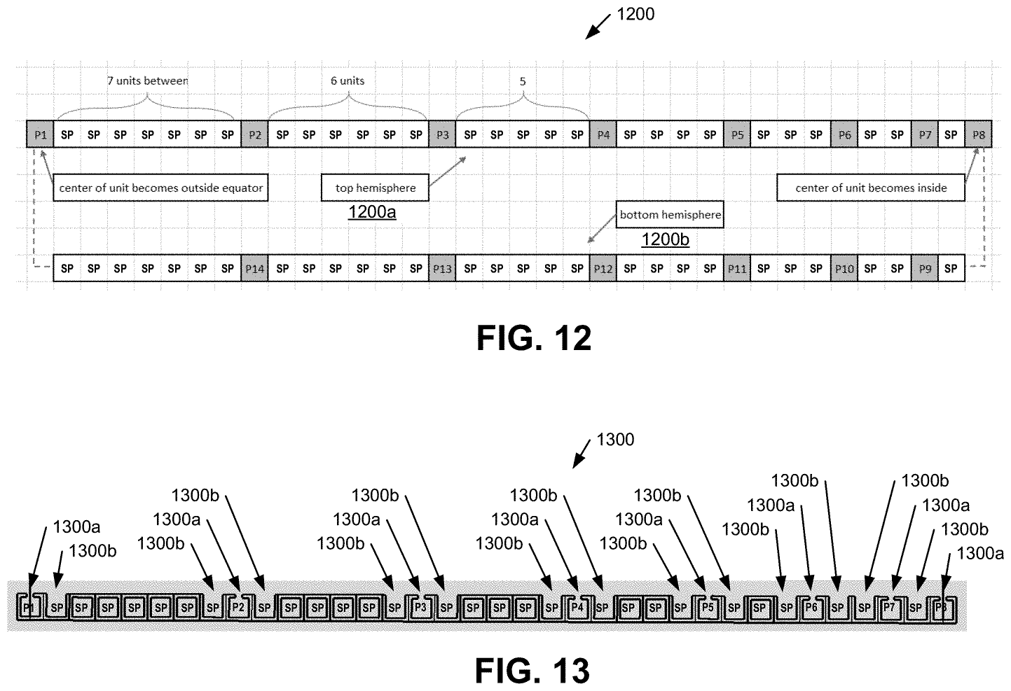

FIG. 12 illustrates an example representation of a design 1200 of a top part 400a shown in FIG. 4A or a bottom part 400b shown in FIG. 4B for building electromagnetic coil structures according to the present disclosure. In some implementations, the top part 400a and the bottom part 400b are designed based on a desired P-value of an electromagnetic coil structure to be built from the parts 400a, 400b. In some implementations, the parts 400a, 400b are designed to comprise the amount of units needed to form a full circle with each of the parts 400a, 400b. In some implementations, the parts 400a, 400b are designed to comprise a top hemisphere 1200a and a bottom hemisphere 1200b.

In some implementations, the parts 400a, 400b are designed to comprise a plurality of P-units “P” in the amount of two-times (2×) the desired P-value of the electromagnetic coil structure to be built from the parts 400a, 400b. For example, in some implementations, for a desired build of a 12T:7P toroidal shaped electromagnetic coil structure, the parts 400a, 400b each comprise fourteen (14) P-units P1-P14 spaced along the parts 400a, 400b with P-units P1-P8 spaced along the top hemisphere 1200a and P-units P8-P14,P1 spaced along the bottom hemisphere 1200b, as represented in FIG. 12. In some implementations, the P-units P are designated units of the parts 400a, 400b spaced along the minor circumference of the intended build of the toroidal shaped electromagnetic coil structure. In some implementations, the P-units P are modified to allow connecting the parts 400a, 400b together and to other parts of the system for building electromagnetic coil structures. In some implementations, the first P-unit P in the top hemisphere 1200a is also the last P-unit P in the bottom hemisphere 1200b of the design 1200 for the parts 400a. 400b. Similarly, in some implementations, the last P-unit P in the top hemisphere 1200a is also the first P-unit P in the bottom hemisphere 1200b of the design 1200 for the parts 400a, 400b.

In some implementations, the units spaced between the P-units P are spacer units “SP”. In some implementations, the number of spacer units SP spaced between the P-units P is based on the P-value of the electromagnetic coil structure to be built from the parts 400a, 400b. In some implementations, the number of spacer units SP spaced between the P-units P increases with respect to an increased P-value of the electromagnetic coil structure to be built from the parts 400a, 400b. In some implementations, the number of spacer units SP spaced between the P-units P on each hemisphere 1200a, 1200b is incrementally decreased by a positive integer constant “c” of appropriate value starting from the P-value. In this way, in some implementations, for each hemisphere 1200a, 1200b, the number of spacer units SP between the first two P-units P is the P-value, the number of spacer units SP between the second two P-units P is the P-value minus the constant c, the number of spacer units SP between the third two P-units P is the P-value minus two-times (2×) the constant c, the number of spacer units SP between the fourth two P-units P is the P-value minus three-times (3×) the constant c, and so on in that pattern to the number of spacer units SP between the last two P-units P which is the P-value minus the result of the P-value minus the constant c. For example, in some implementations, for the desired build of the 12T:7P toroidal shaped electromagnetic coil structure introduced above, the parts 400a, 400b each comprise seven (7) spacer units between the P-units P1, P2 on the top hemisphere 1200a and the P-units P14, P1 on the bottom hemisphere 1200b, six (6) spacer units between the P-units P2, P3 on the top hemisphere 1200a and the P-units P13, P14 on the bottom hemisphere 1200b, five (5) spacer units between the P-units P3, P4 on the top hemisphere 1200a and the P-units P12, P13 on the bottom hemisphere 1200b, and so on in that pattern to one (1) spacer unit between the P-units P7, P8 on the top hemisphere 1200a and the P-units P8, P9 on the bottom hemisphere 1200b.

In some implementations, the first P-unit P in the top hemisphere 1200a, which is also the last P-unit P in the bottom hemisphere 1200b, is positioned on the outer equator 1000c of the toroidal shaped electromagnetic coil structure 1000 represented in FIG. 10 that is built with the parts 400a, 400b shown in FIGS. 4A and 4B. In some implementations, the last P-unit P in the top hemisphere 1200a, which is also the first P-unit P in the bottom hemisphere 1200b, is positioned on the inner equator 1000d of the toroidal shaped electromagnetic coil structure 1000 built with the parts 400a, 400b. For example, in some implementations, for the desired build of the 12T:7P toroidal shaped electromagnetic coil structure, the P-unit P1 is positioned on the outer equator 1000c and the P-unit P8 is positioned on the inner equator 1000d.

FIG. 13 illustrates an implementation of an example main row 1300 of a top part 400a shown in FIG. 4A or a bottom part 400b shown in FIG. 4B for building electromagnetic coil structures according to the present disclosure. In some implementations, the main row 1300 is a physical correlation to the top hemisphere 1200a of the design 1200 shown in FIG. 12. In some implementations, the main row 1300 is also a similar physical correlation to the bottom hemisphere 1200b of the design 1200 shown in FIG. 12. In some implementations, the P-units P of the main row 1300 each comprise an opening or notch 1300a. In some implementations, each P-unit notch 1300a is centered on the corresponding P-unit P. In some implementations, each P-unit notch 1300a comprises a width equal to the width of the flat stock material discussed further below of which the parts 400a, 400b and other parts of the system for building electromagnetic coil structures are composed. In some implementations, the P-unit notches 1300a are configured to allow the parts 400a, 400b composed of the main row 1300 to be connected together or to other parts of the system for building electromagnetic coil structures.

In some implementations, the spacer units SP adjacent to each P-unit P of the main row 1300 each comprise an opening or notch 1300b. In some implementations, each spacer unit notch 1300b comprises a width equal to the width of the spacer unit SP. In some implementations, the spacer unit notches 1300b are configured to hold, support, or route one or more wraps of magnet wire for building electromagnetic coils. In some implementations, the spacer unit notches 1300b are configured to allow the parts 400a, 400b composed of the main row 1300 to have flexibility to be shaped and to be connected together or to other parts to build electromagnetic coil structures according to the present disclosure.

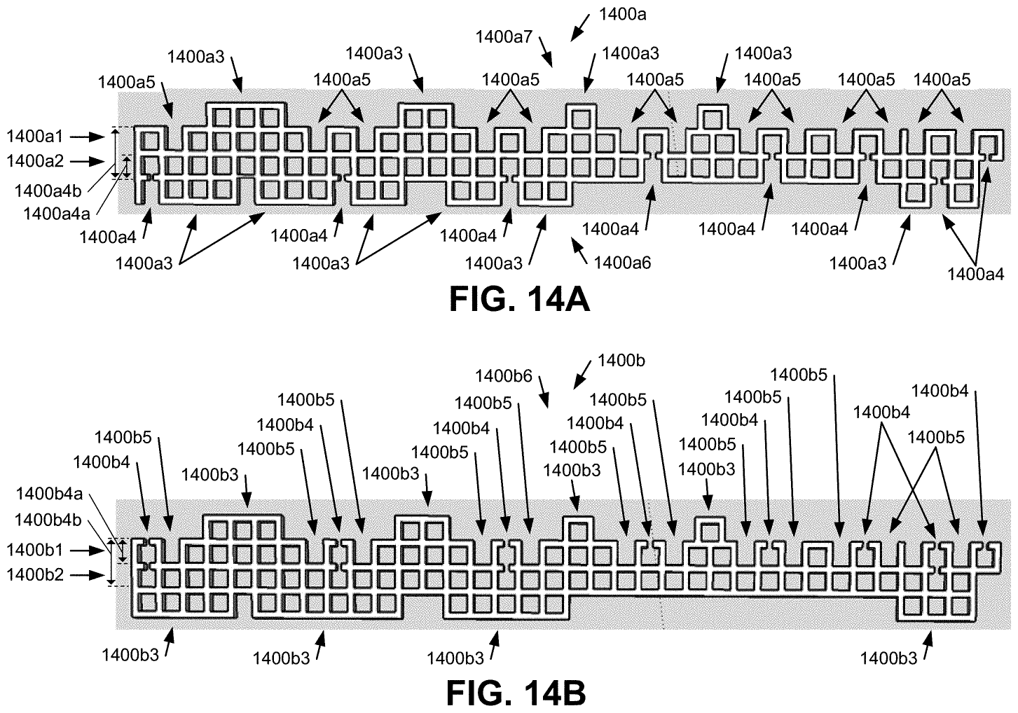

FIGS. 14A and 14B illustrate implementations of an example pre-final form of a top part 1400a and a bottom part 1400b for building electromagnetic coil structures according to the present disclosure. In some implementations, the pre-final parts 1400a, 1400b comprise a main row 1400a1, 1400b1, one or more additional rows 1400a2, 1400b2, and one or more additional units 1400a3, 1400b3. In some implementations, the main row 1400a1, 1400b1 is the same or similar to the main row 1300 described above for FIG. 13. In some implementations, the main row 1400a1, 1400b1 comprises P-unit notches 1400a4, 1400b4 that are similar to the P-unit notches 1300a described above for FIG. 13. In some implementations, the P-unit notches 1400a4, 1400b4 comprise a depth 1400a4a, 1400b4a that is at least half of the total width 1400a4b, 1400b4b of the main row 1400a1, 1400b1 and the additional rows 1400a2, 1400b2 as shown in FIGS. 14A and 14B. In some implementations, the P-unit notches 1400a4 are open from the bottom side 1400a6 of the top part 1400a through one or more units including the P-units. In some implementations, the P-unit notches 1400b4 are open from the top side 1400b6 of the bottom part 1400b through one or more units including the P-units. In some implementations, the depth 1400a4a, 1400b4a of the P-unit notches 1400a4, 1400b4 is configured to allow the top part 1400a and the bottom part 1400b to connect together by pushing one of the respective P-unit notches 1400a4 and 1400b4 together so that the top side 1400b6 of the bottom part 1400b is at least partially aligned or flush with the top side 1400a7 of the top part 1400a, as discussed further below.

In some implementations, the main row 1400a1, 1400b1 comprises spacer unit notches 1400a5, 1400b5 that are the same or similar to the spacer unit notches 1300b described above for FIG. 13.

In some implementations, the additional row 1400a2, 1400b2 of spacer units SP is added below the main row 1400a1, 1400b1. In some implementations, the additional units 1400a3, 1400b3 are added above the main row 1400a1, 1400b1 and below the additional row 1400a2, 1400b2. In some implementations, the additional units 1400a3, 1400b3 are also called “shoulder units” 1400a3, 1400b3. In some implementations, the additional units 1400a3, 1400b3 are added to provide additional structural support to the parts 1400a, 1400b. In some implementations, the additional units 1400a3, 1400b3 are added to provide for additional connections of the parts 1400a, 1400b to other parts of the system for building electromagnetic coil structures.

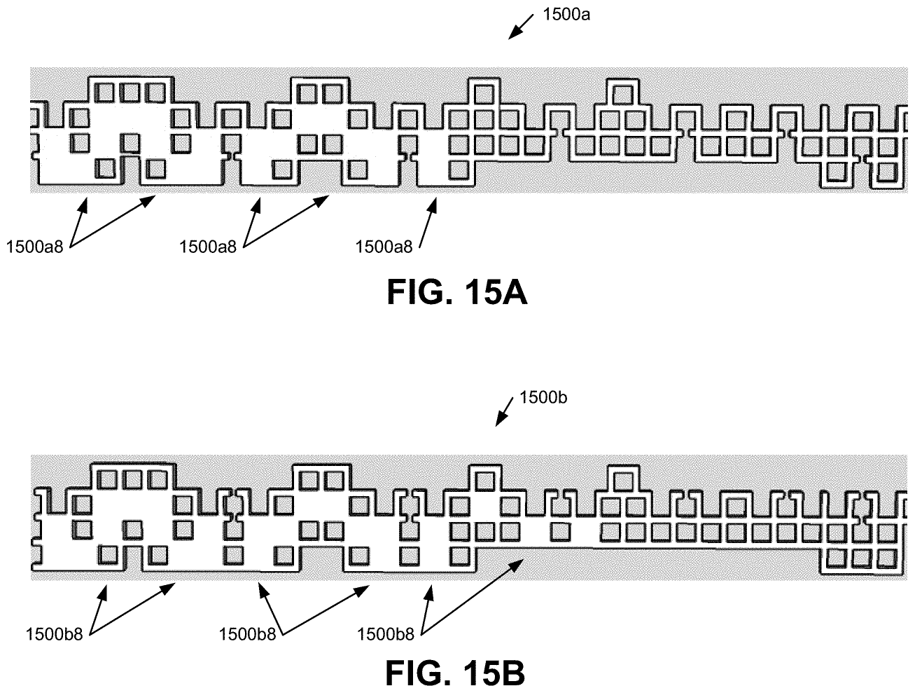

FIGS. 15A and 15B illustrate other implementations of an example pre-final form of a top part 1500a and a bottom part 1500b for building electromagnetic coil structures according to the present disclosure. In some implementations, the parts 1500a, 1500b are the same or similar to the parts 1400a, 1400b described above for FIGS. 14A and 14B except that one or more of the spacer units 1500a8, 1500b8 of the parts 1500a, 1500b do not comprise an opening through the parts 1500a, 1500b. In some implementations, some of the spacer units SP can be solid or filled with the parts 1500a, 1500b and still able to function the same as the parts 1400a, 1400b of FIGS. 14A and 14B. In some implementations, openings are included in at least some of the spacer units SP as shown in FIGS. 15A and 15B to allow the parts 1500a, 1500b to have sufficient flexibility for use in the system and method for building electromagnetic coil structures. In some implementations, the solid units may allow quicker or easier fabrication of the parts 1500a, 1500b.

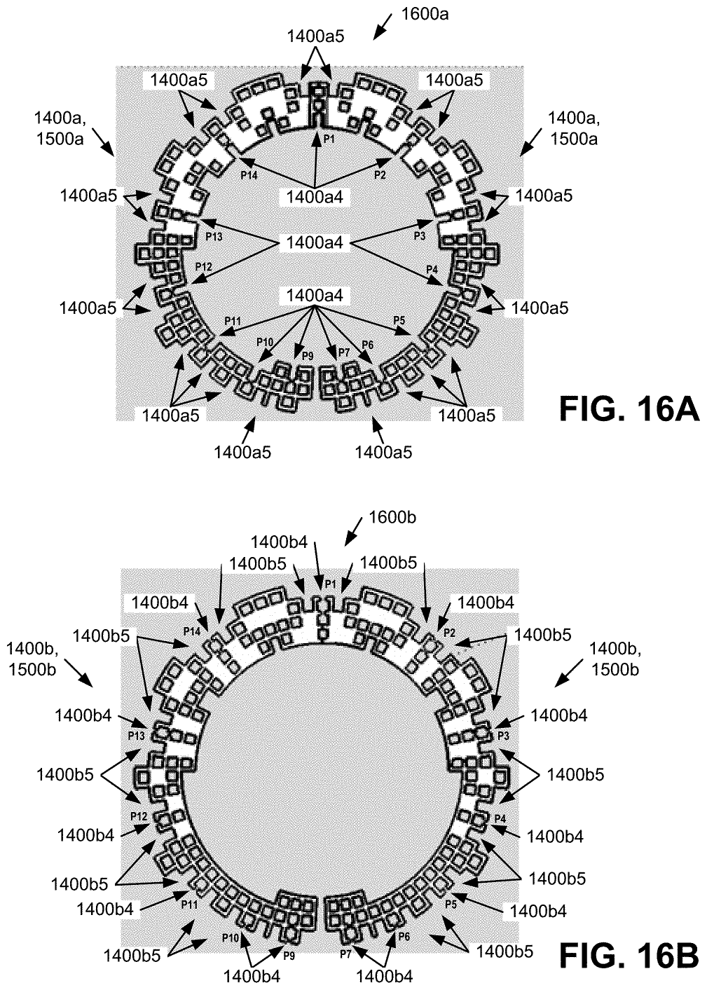

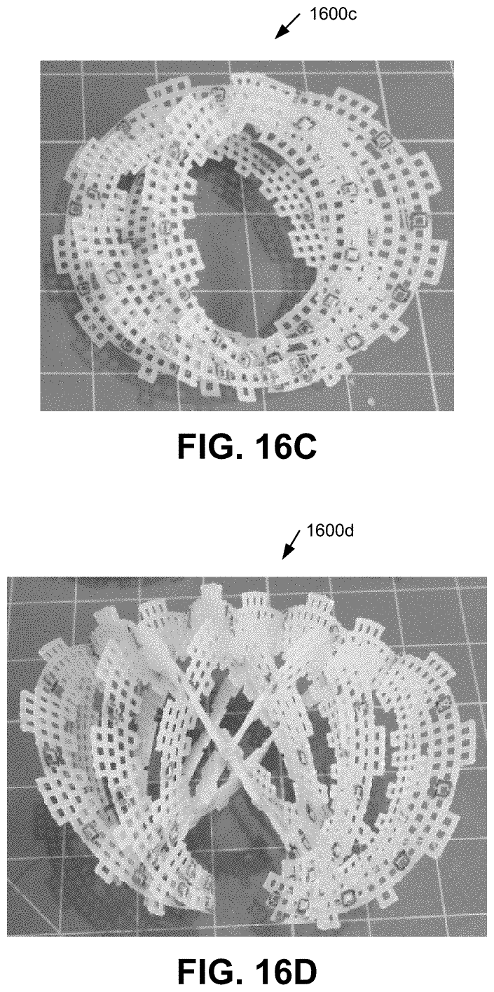

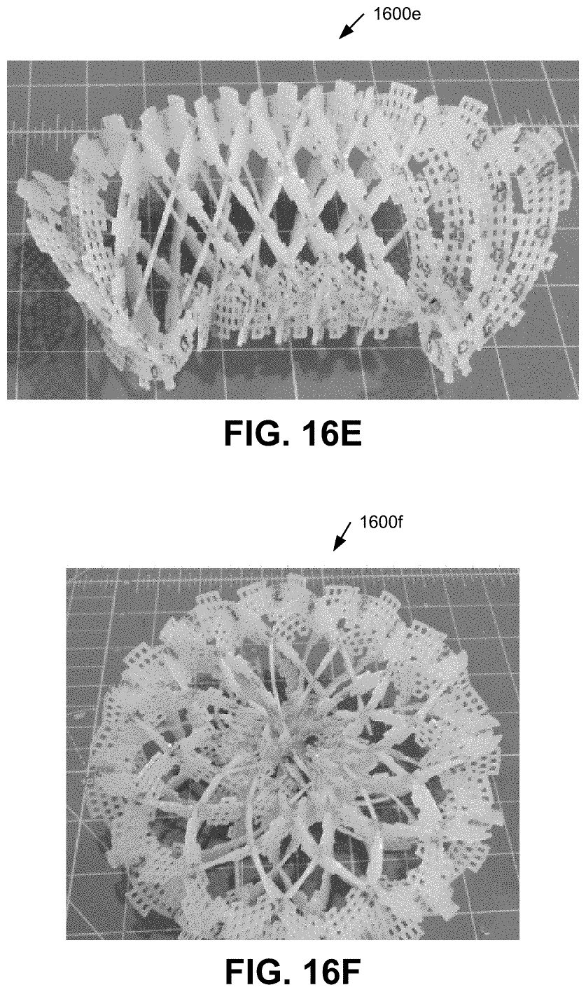

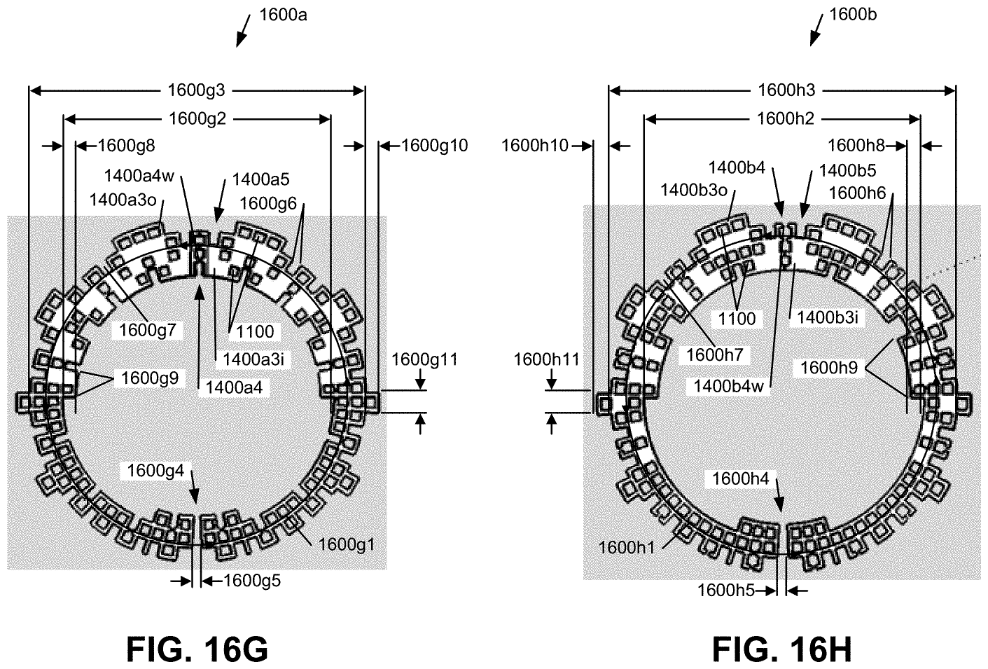

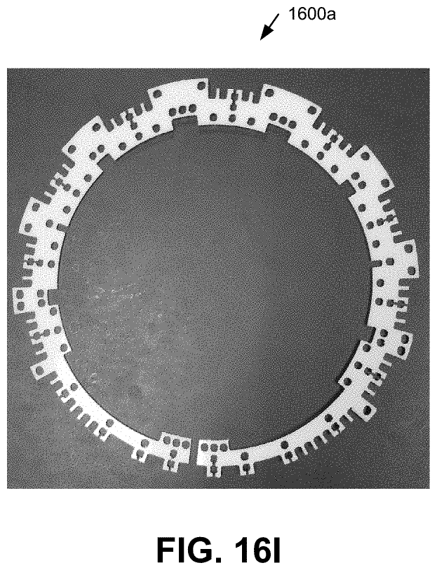

FIGS. 16A and 16B illustrate implementations of an example final form of a top part 1600a and a bottom part 1600b for building electromagnetic coil structures according to the present disclosure. In some implementations, the parts 1600a, 1600b are the same or similar to the parts 400a, 400b described above for FIGS. 4A and 4B. In some implementations, the top part 1600a shown in FIG. 16A comprises the same or similar parts 1400a, 1500a described above for FIGS. 14A and 15A. In some implementations, the top part 1600a comprises the same or similar P-unit notches 1400a4 (P1-P7, P9-P14) as described above for FIG. 14A. In some implementations, the top part 1600a comprises the same or similar spacer unit notches 1400a5 as described above for FIG. 14A. In some implementations, the parts 1400a, 1500a are bent or curved to form the circular shaped top part 1600a. In some implementations, the parts 1400a, 1500a are fabricated curved to form the circular shaped top part 1600a. In some implementations, the unit of the parts 1400a, 1500a that falls on the inside edge of the parts 1400a, 1500a is removed to compose the top part 1600a. For example, in the 12T:7P design, the P-unit P8 described above for FIG. 12 is removed from the parts 1400a, 1500a composing the top part 1600a.

In some implementations, the bottom part 1600b shown in FIG. 16B comprises the same or similar parts 1400b, 1500b described above for FIGS. 14B and 15B. In some implementations, the bottom part 1600b comprises the same or similar P-unit notches 1400b4 (P1-P7, P9-P14) as described above for FIG. 14B. In some implementations, the bottom part 1600b comprises the same or similar spacer unit notches 1400b5 as described above for FIG. 14B. In some implementations, the parts 1400b, 1500b are bent or curved to form the circular-shaped bottom part 1600b. In some implementations, the parts 1400b, 1500b are fabricated curved to form the circular-shaped bottom part 1600b. In some implementations, the unit of the parts 1400b, 1500b that falls on the inside edge of the parts 1400b, 1500b is removed to compose the bottom part 1600b. For example, in the 12T:7P design, the P-unit P8 described above for FIG. 12 is removed from the parts 1400b, 1500b composing the bottom part 1600b.

FIG. 16I illustrates another implementation of an example final form of a bottom part 1600i for building electromagnetic coil structures according to the present disclosure. In some implementations, the bottom part 1600i is the same or similar to the bottom part 1600b described above for FIG. 16B except that the bottom part 1600i comprises fewer spacer unit openings through the part 1600i. In some implementations, the bottom part 1600i comprises at least a minimum of needed spacer unit openings through the part 1600i, as described above for the parts 1500a, 1500b of FIGS. 15A and 15B and described further below with respect to fabrication of the parts of the system for building electromagnetic coil structures.

In some implementations, as described further below, the parts 1600a, 1600b are configured to connect together and to other parts of the system for building electromagnetic coil structures. In some implementations, the parts 1600a, 1600b are configured to connect together and to the other parts at the P-unit notches 1400a4, 1400b4. FIGS. 16C-16F illustrate examples 1600c-f of the final form of the top part 1600a and the bottom part 1600a shown in FIGS. 16A and 16B connected together for building electromagnetic coil structures according to the present disclosure.

In some implementations, the parts 1600a, 1600b, 400a, 400b are also referred to as “P-parts” or “P-dividers” since the design of the parts 1600a, 1600b, 400a, 400b is based on the P-value of the electromagnetic coil structure to be built. In some implementations, the number of parts 1600a, 1600b, 400a, 400b used to build the electromagnetic coil structure is based on the T-value of the electromagnetic coil structure to be built. For example, in some implementations, for a 12T:7P electromagnetic coil structure, twelve (12) top parts 1600a and twelve (12) bottom parts 1600b are used to build the electromagnetic coil structure.

FIGS. 16G and 16H illustrate example parameters of the final form of the top part 1600a and the bottom part 1600b shown in FIGS. 16A and 16B. As shown in FIG. 16G, in some implementations, the top part 1600a comprises a flat, ring shape with a circumferential surface 1600g1 between an inner diameter 1600g2 and an outer diameter 1600g3, such as an annular ring shape. In some implementations, the top part 1600a comprises a gap 1600g4 in the circumferential surface 1600g1 that extends from the inner diameter 1600g2 to the outer diameter 1600g3. In some implementations, the gap 1600g4 has a width 1600g5 that is at most the difference between the outer diameter 1600g3 and the inner diameter 1600g4.

In some implementations, the top part 1600a comprises a plurality of P-unit notches or “connection notches” 1400a4 (described above for FIG. 14A) opening into the circumferential surface 1600g1 from the inner diameter 1600g2 and spaced apart along the inner diameter 1600g2. In some implementations, the connection notches 1400a4 have a width 1400a4w that is at least the same as the thickness of the circumferential surface 1600g1 (such as the thickness of the flat stock materials described below). In some implementations, the connection notches 1400a4 have a depth 1400a4a (shown in and described above for FIG. 14A) extending from the inner diameter 1600g2 into the circumferential surface 1600g1 that is at least half of the difference between the outer diameter 1600g3 and the inner diameter 1600g2. In some implementations, the connection notches 1400a4 are configured to connect to other of the plurality of parts of the system for building electromagnetic coil structures as described above for FIG. 14A.

In some implementations, the top part 1600a comprises a plurality of spacer unit notches or “wire notches” 1400a5 (described above for FIG. 14A) opening into the circumferential surface 1600g1 from the outer diameter 1600g3. In some implementations, the wire notches 1400a5 are spaced apart along the outer diameter 1600g3 and aligned adjacent to each side of the connection notches 1400a4. In some implementations, the wire notches 1400a5 have a width 1600g6 that is at least the same as the thickness of the circumferential surface 1600g1. In some implementations, the wire notches 1400a5 have a depth 1600g7 extending from the outer diameter 1600g3 into the circumferential surface 1600g1 that is at least the same as the thickness of the circumferential surface 1600g1. In some implementations, the wire notches 1400a5 are configured to receive magnet wire within the wire notches 1400a5 to build electromagnetic coils as described above for FIGS. 13 and 14A.

In some implementations, the top part 1600a comprises a plurality of additional units 1400a3 or “inward extensions 1400a3i” (described above for FIG. 14A) of the circumferential surface 1600g1 extending from the inner diameter 1600g2 and spaced apart along the inner diameter 1600g2 aligned between the connection notches 1400a4. In some implementations, the inward extensions 1400a3i have a length 1600g8 extending from the inner diameter 1600g2 of at least the thickness of the circumferential surface 1600g1. In some implementations, the inward extensions 1400a3i have a width 1600g9 of at least the thickness of the circumferential surface 1600g1. In some implementations, the inward extensions 1400a3i have at least one opening 1100 (described above for FIGS. 11A-11C and 12) through each inward extension 1400a3i configured to connect to other of the plurality of parts of the system for building electromagnetic coil structures.

In some implementations, the top part 1600a comprises a plurality of additional units 1400a3 or “outward extensions 1400a3o” (described above for FIG. 14A) of the circumferential surface 1600g1 extending from the outer diameter 1600g3 and spaced apart along the outer diameter 1600g3 aligned between the wire notches 1400a5. In some implementations, the outward extensions 1400a3o have a length 1600g10 extending from the outer diameter 1600g3 of at least the thickness of the circumferential surface 1600g1. In some implementations, the outward extensions 1400a3o have a width 1600g11 of at least the thickness of the circumferential surface 1600g1. In some implementations, the outward extensions 1400a3o have at least one opening 1100 (described above for FIGS. 11A-11C and 12) through each outward extension 1400a3o configured to connect to other of the plurality of parts of the system for building electromagnetic coil structures.

As shown in FIG. 16H, in some implementations, the bottom part 1600b comprises a flat, ring shape with a circumferential surface 1600h1 between an inner diameter 1600h2 and an outer diameter 1600h3, such as an annular ring shape. In some implementations, the bottom part 1600b comprises a gap 1600h4 in the circumferential surface 1600h1 that extends from the inner diameter 1600h2 to the outer diameter 1600h3. In some implementations, the gap 1600h4 has a width 1600h5 that is at most the difference between the outer diameter 1600h3 and the inner diameter 1600h4.

In some implementations, the bottom part 1600b comprises a plurality of P-unit notches or “connection notches” 1400b4 (described above for FIG. 14B) opening into the circumferential surface 1600h1 from the outer diameter 1600h3 and spaced apart along the outer diameter 1600h3. In some implementations, the connection notches 1400b4 have a width 1400b4w that is at least the same as the thickness of the circumferential surface 1600h1 (such as the thickness of the flat stock materials described below). In some implementations, the connection notches 1400b4 have a depth 1400b4a (shown in and described above for FIG. 14B) extending from the outer diameter 1600h3 into the circumferential surface 1600h1 that is at least half of the difference between the outer diameter 1600h3 and the inner diameter 1600h2. In some implementations, the connection notches 1400b4 are configured to connect to other of the plurality of parts of the system for building electromagnetic coil structures as described above for FIG. 14B.

In some implementations, the bottom part 1600b comprises a plurality of spacer unit notches or “wire notches” 1400b5 (described above for FIG. 14B) opening into the circumferential surface 1600h1 from the outer diameter 1600h3. In some implementations, the wire notches 1400b5 are spaced apart along the outer diameter 1600h3 adjacent to each side of the connection notches 1400b4. In some implementations, the wire notches 1400b5 have a width 1600h6 that is at least the same as the thickness of the circumferential surface 1600h1. In some implementations, the wire notches 1400b5 have a depth 1600h7 extending from the outer diameter 1600h3 into the circumferential surface 1600h1 that is at least the same as the thickness of the circumferential surface 1600h1. In some implementations, the wire notches 1400b5 are configured to receive magnet wire within the wire notches 1400b5 to build electromagnetic coils as described above for FIGS. 13 and 14B.

In some implementations, the bottom part 1600b comprises a plurality of additional units 1400b3 or “inward extensions 1400b3i” (described above for FIG. 14B) of the circumferential surface 1600h1 extending from and spaced apart along the inner diameter 1600h2. In some implementations, the inward extensions 1400b3i have a length 1600h8 extending from the inner diameter 1600h2 of at least the thickness of the circumferential surface 1600h1. In some implementations, the inward extensions 1400b3i have a width 1600h9 of at least the thickness of the circumferential surface 1600h1. In some implementations, the inward extensions 1400b3i have at least one opening 1100 (described above for FIGS. 11A-11C and 12) through each inward extension 1400b3i configured to connect to other of the plurality of parts of the system for building electromagnetic coil structures.

In some implementations, the bottom part 1600b comprises a plurality of additional units 1400b3 or “outward extensions 1400b3o” (described above for FIG. 14B) of the circumferential surface 1600h1 extending from the outer diameter 1600h3 and spaced apart along the outer diameter 1600h3 aligned between the wire notches 1400b5. In some implementations, the outward extensions 1400b3o have a length 1600h10 extending from the outer diameter 1600h3 of at least the thickness of the circumferential surface 1600h1. In some implementations, the outward extensions 1400b3o have a width 1600h11 of at least the thickness of the circumferential surface 1600h1. In some implementations, the outward extensions 1400b3o have at least one opening 1100 (described above for FIGS. 11A-11C and 12) through each outward extension 1400b3o configured to connect to other of the plurality of parts of the system for building electromagnetic coil structures.

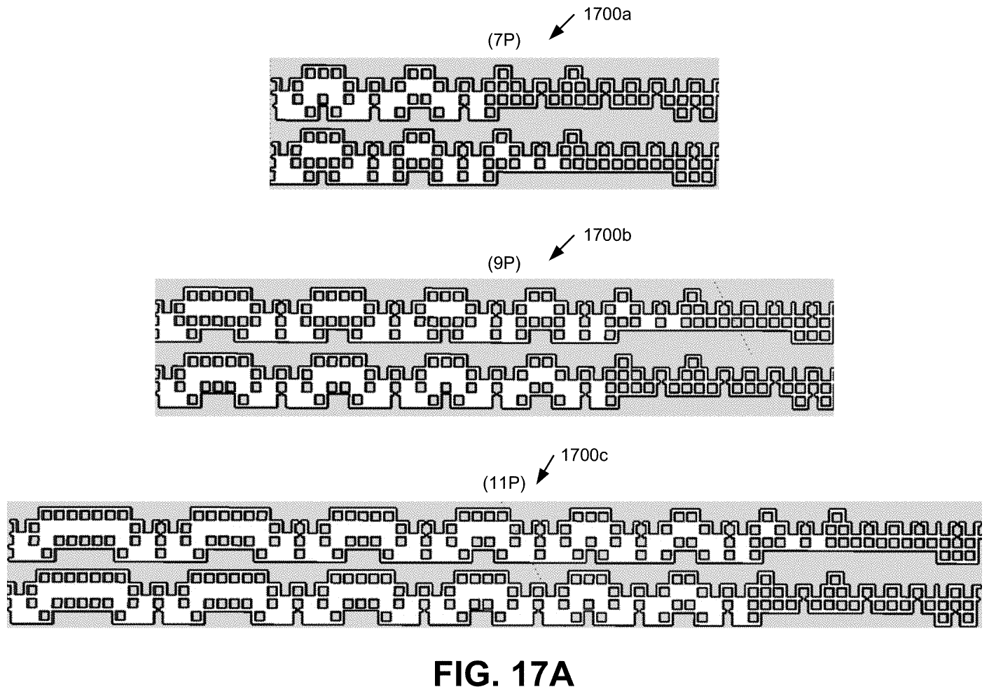

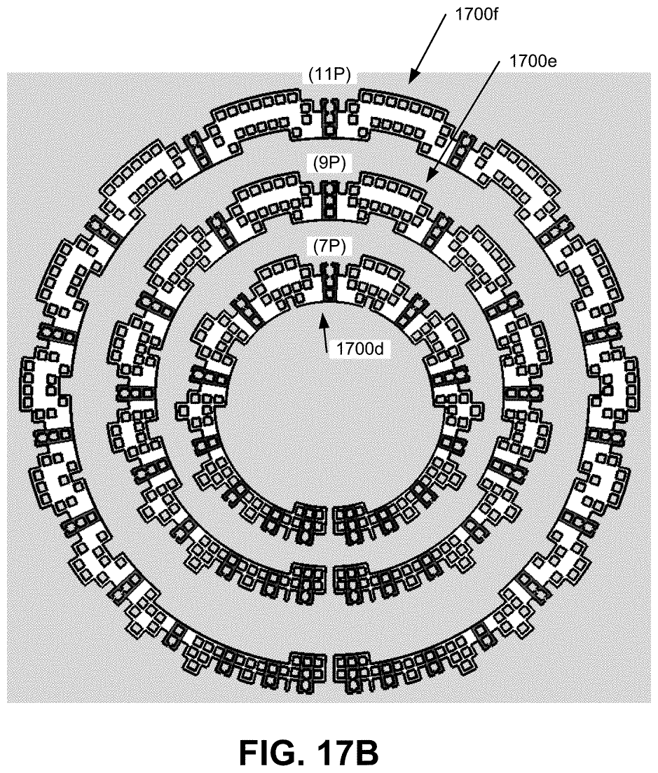

FIGS. 17A and 17B illustrate implementations of example pre-final form parts 1700a, 1700b, 1700c and corresponding final form parts 1700d, 1700e, 1700f with varying P-values for building electromagnetic coil structures according to the present disclosure. In some implementations, the pre-final form parts 1700a, 1700b, 1700c are the same or similar to the parts 1400a, 1400b of FIGS. 14A and 14B and the parts 1500a, 1500b of FIGS. 15A and 15B described above. In some implementations, the final form parts 1700d, 1700e, 1700f are the same or similar to the parts 1600a, 1600b of FIGS. 16A and 16B described above. In some implementations, the pre-final form parts 1700a, 1700b, 1700c and the corresponding final form parts 1700d, 1700e, 1700f have varying P-values of 7P, 9P, and 11P respectively as indicated in FIGS. 17A and 17B. As shown, in some implementations, the physical size of the parts 1700a-f increases as the P-value of the parts 1700a-f increases. In some implementations, as discussed above for FIG. 12, the number of P-units P and spacer units SP in the design of the parts 1700a-f increases as the P-value of the design of the parts 1700a-f is increased. In some implementations, therefore, final form parts 1700d-f with lower P-values can fit within other final form parts 1700d-f. For example, in some implementations, a 7P part 1700d can fit within a 9P part 1700e, and both parts 1700d,e can fit within an 11P part 1700f, as shown in FIG. 17B. In this way, in some implementations, various multi-shelled or other complex electromagnetic core structures can be built with the parts 1700d-f such as discussed above for FIGS. 3A-3C.

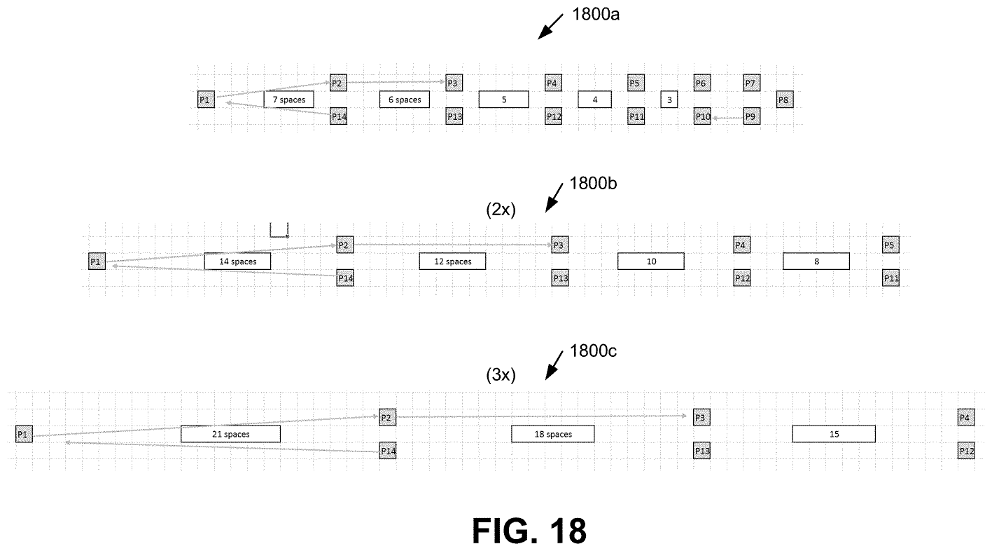

In some implementations, the parts 1700a-f can be incrementally increased in physical size by maintaining the number of P-units P in the design of the parts 1700a-f while increasing the number of spacer units SP between the P-units P of the parts 1700a-f. For example, the parts 1700a-f can be incrementally increased in size by adding a multiple of the number of spacer units SP between the P-units P in the original design of the parts 1700a-f. In this way, the parts 1700a-f can be increased in size while maintaining the originally intended P-value structure and function for building electromagnetic coil structures. For example, FIG. 18 illustrates an example representation of an incrementally size-increased design 1800b,c for a top part or a bottom part for building electromagnetic coil structures according to the present disclosure. In some implementations, as shown in FIG. 18, a multiple of two-times (2×) the number of spacer units SP are added between the P-units of a design 1800a to form the incrementally size-increased design 1800b. In some implementations, as shown in FIG. 18, a multiple of three-times (3×) the number of spacer units SP are added between the P-units of a design 1800a to form the incrementally size-increased design 1800c. As discussed above for FIG. 12, the design 1800b,c with the added spacer units SP can be used to compose a top part 400a, 1600a or a bottom part 400b, 1600b for building electromagnetic coil structures according to the present disclosure.

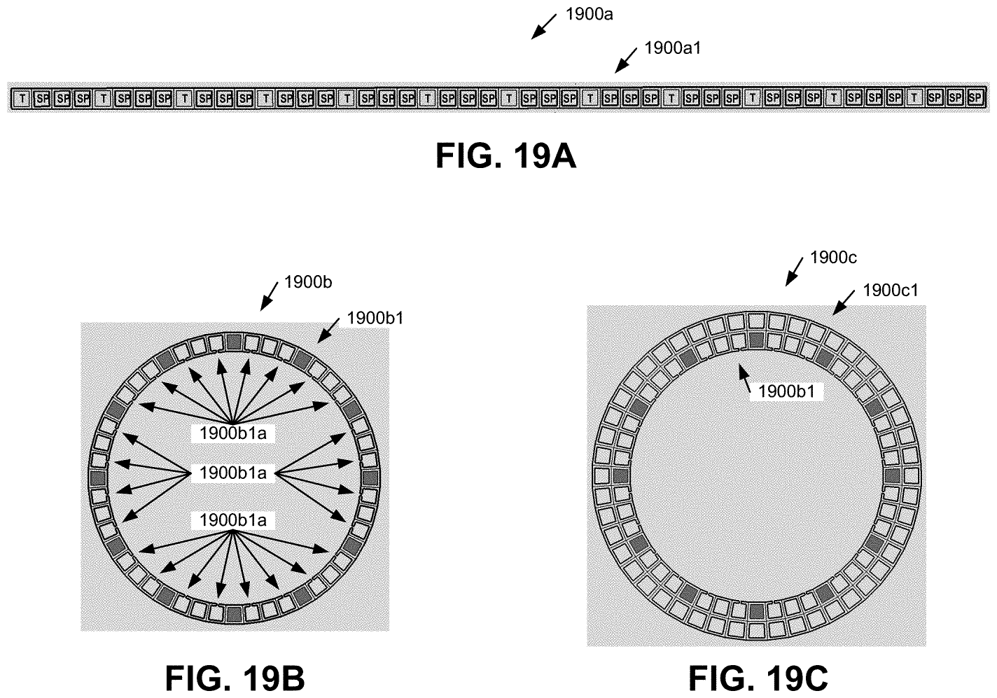

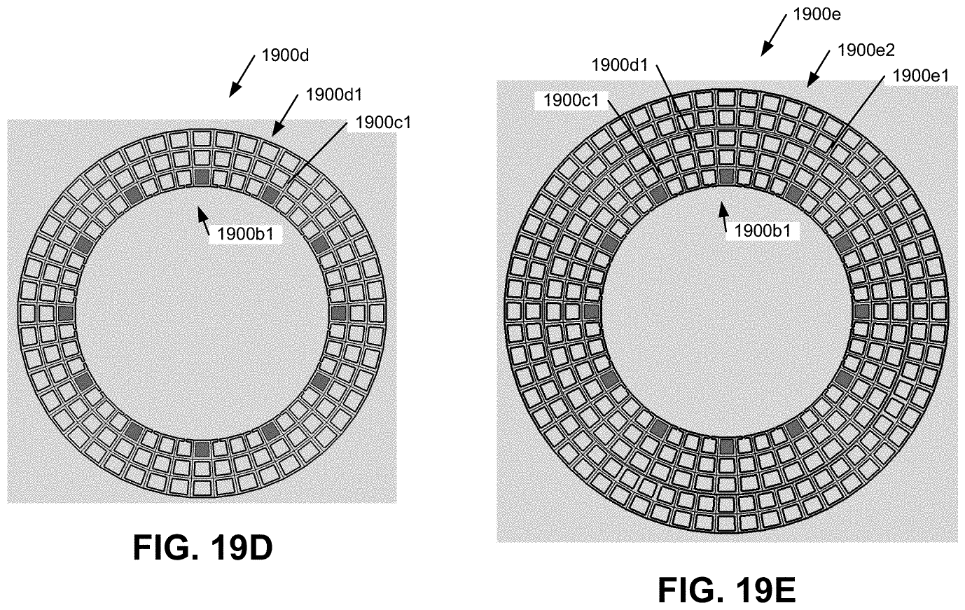

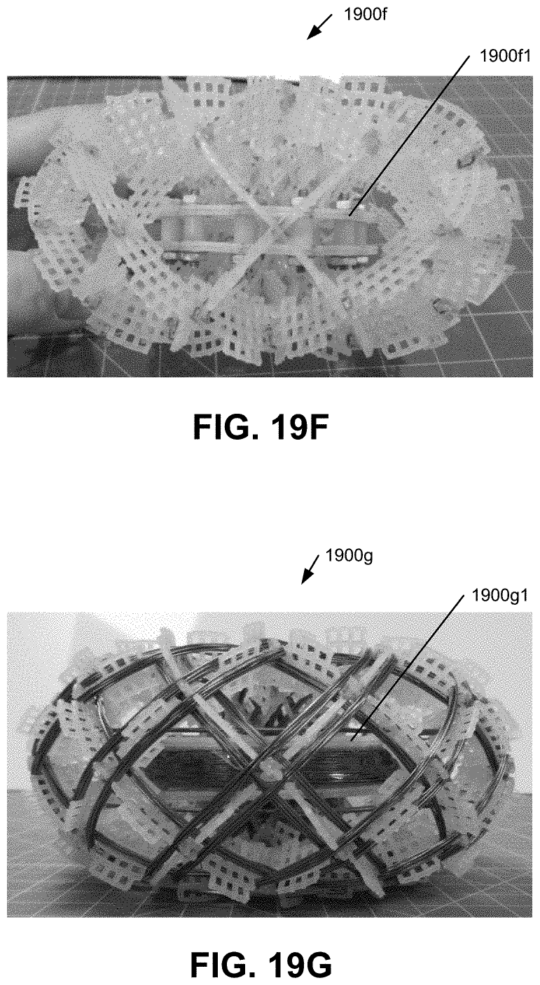

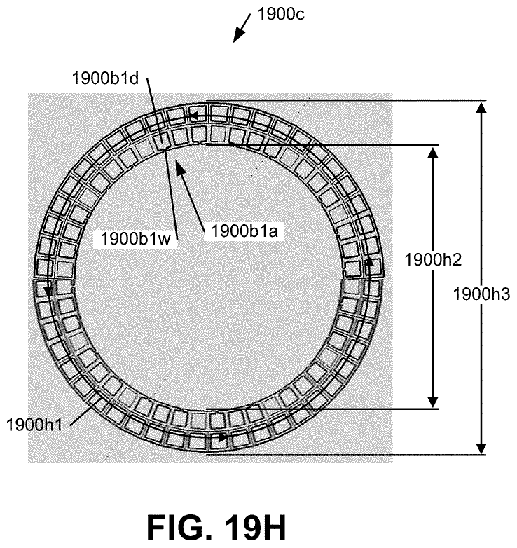

FIGS. 19A-19E illustrate implementations of example hub circles 1900a-e according to the present disclosure. In some implementations, the hub circles 1900a-e are the same or similar to the hub circles 500a shown in FIG. 5A. In some implementations, the hub circles 1900a-e comprise a main ring 1900a1,b1 as shown in FIGS. 19A and 19B and additional surrounding rings 1900c1-e2 as shown in FIGS. 19C-19E. In some implementations, the main ring 1900b1 is the main ring 1900a1 curved into the final ring shape form of the hub circles 1900b-e. In some implementations, the main ring 1900a1,b1 is the innermost ring in multi-ring hub circles 1900c-e. In some implementations, the hub circles 1900a-e comprise units that are the same or similar to the units 1100 described above for FIGS. 11A-11C and 12. In some implementations, the number of units comprised in each ring 1900a1-e2 of the hub circles 1900a-e is based on the T-value of the electromagnetic coil structure to be built from the parts of the system for building electromagnetic coil structures.

In some implementations, the main ring 1900a1,b1 comprises T-units “T” as marked in FIG. 19A and indicated by shading in FIGS. 19A-19E. In some implementations, the number of T-units T of the main ring 1900a1,b1 corresponds to the T-value of the electromagnetic coil structure to be built. For example, in some implementations, for a 12T:7P electromagnetic coil structure, the main ring 1900a1,b1 comprises 12 T-units T. In some implementations, the T-units T are spaced between a plurality of spacer units “SP” along the main ring 1900a1,b1. In some implementations, the spacer units SP are the same or similar to the spacer units SP described above for FIGS. 11A-11C and 12. In some implementations, each of the T units T are spaced between the same number of spacer units “SP” along the main ring 1900a,b. In some implementations, the number of spacer units SP in the main ring 1900a1,b1 is a multiple of the T-value of the electromagnetic coil structure to be built. In some implementations, the number of spacer units SP in the main ring 1900a1,b1 is at least three-times (3×) the T-value. For example, in some implementations, in a 12T:7P electromagnetic coil structure, the main ring 1900a1,b1 comprises thirty-six (36) spacer units SP with three (3) spacer units SP between each of the T-units T for a total of forty-eight (48) units as shown in FIGS. 19A-19E.

In some implementations, each spacer unit SP adjacent to a T-unit T in the main ring 1900b1 comprises an opening or notch 1900b1a that is similar to the P-unit notches 1300a described above for FIG. 13. That is, in some implementations, each spacer unit notch 1900b1a may be centered on the corresponding spacer unit SP, comprises a width equal to the width of the flat stock material of which the hub circles 1900a-e and other parts are composed, and is configured to allow other parts to be connected to the hub circles 1900b-e. In some implementations, the spacer unit notches 1900b1a comprise a depth that is at most the same as the width of the spacer unit. In some implementations, the spacer unit notches 1900b1a open or face inward toward the center of the hub circles 1900b-e since the main ring 1900b1 is the innermost ring.

In some implementations, additional rings 1900c1-e2 are added around the main ring 1900b1 to form multi-ring hub circles 1900c-e of varying sizes. In some implementations, the additional rings 1900c1-e2 comprise spacer units SP. In some implementations, the number of spacer units SP in the additional rings 1900c1-e2 is a multiple of the T-value of the electromagnetic coil structure to be built that fits around the main ring 1900b1. In some implementations, the number of spacer units SP in the additional rings 1900c1-e2 is divisible by the T-value of the electromagnetic coil structure to be built that fits around the main ring 1900b1. In some implementations, the number of spacer units SP in the additional rings 1900c1-e2 is at least the total number of T-units T and spacer units SP in the main ring 1900b1. For example, in some implementations, in a 12T:7P electromagnetic coil structure, the additional rings 1900c1,d1 each comprise forty-eight (48) spacer units SP. In some implementations, the number of spacer units SP in one or more of the additional rings 1900c1-e2 increases to fit around the main ring 1900b as the additional rings 1900c1-e2 are added around the main ring 1900b1. In some implementations, the number of spacer units SP in the one or more additional rings 1900c1-e2 increases to also maintain the unit size of the one or more additional rings 1900c1-e2. For example, in some implementations, in the 12T:7P electromagnetic coil structure, the additional rings 1900e1,e2 each comprise sixty (60) spacer units SP to fit around the additional rings 1900c1,d1 and the main ring 1900b1 while maintaining the unit size of the additional rings 1900e1,e2 and being divisible by the 12T-value.

In some implementations, a hub circle 1900a-e can be used in building an electromagnetic coil structure if the total number of units in the main ring 1900b1 is divisible by the T-value of the electromagnetic coil structure. For example, in some implementations, a hub circle with a main ring 1900b1 comprising forty-eight (48) units can be used in building a 16T electromagnetic coil structure with various P-values.

In some implementations, a hub 502 shown in FIG. 5B can be built from one or more finished hub circles 500a using one or more hub parts 500b shown in FIG. 5A. In some implementations, the hub parts 500b comprise connecting parts such as threaded rods 500b1, spacers 500b2, washers 500b3, locknuts 500b4, or any other suitable parts. In some implementations, the configuration of the hub 502 is based on the intended design of the electromagnetic coil structure to be built. In some implementations, the configuration of the hub 502 is based on the configuration of one or more of the parts used to build the electromagnetic coil structure. For example, in some implementations, the overall height of the hub 502 is relative to the gap 400a1 in the top part 400a shown in FIG. 4A.

FIGS. 19F and 19G illustrate implementations of example electromagnetic coil structures 1900f,g that include a hub 1900f1,g1 according to the present disclosure. In some implementations, the hub 1900f1,g1 is the same or similar to the hub 502 described above. In some implementations, the hub 1900f1,g1 is configured to support and maintain the structure of electromagnetic coil structures built according to the present disclosure as shown in FIG. 19F. In some implementations, the hub 1900f1,g1 is configured to provide additional structure for building electromagnetic coils with magnet wire according to the present disclosure as shown in FIG. 19G.

FIG. 19H illustrates example parameters of the hub circles 1900a-e shown in FIGS. 19A-19E, such as the hub circle 1900c shown in FIG. 19C. In some implementations, the hub circle 1900c comprises a flat, ring shape with a circumferential surface 1900h1 between an inner diameter 1900h2 and an outer diameter 1900h3, such as an annular ring shape. In some implementations, the hub circle 1900c comprises a plurality of spacer unit notches or “connection notches” 1900b1a (described above for FIGS. 19A-19E) opening into the circumferential surface 1900h1 from the inner diameter 1900h2 and spaced apart along the inner diameter 1900h2. In some implementations, the connection notches 1900b1a have a width 1900b1w that is at least the same as the thickness of the circumferential surface 1900h1 (such as the thickness of the flat stock materials described below). In some implementations, the connection notches 1900b1a have a depth 1900b1d extending from the inner diameter 1900h2 into the circumferential surface 1900h1 that is at least the same as the thickness of the circumferential surface 1900h1. In some implementations, the connection notches 1900b1a are configured to connect to other of the plurality of parts of the system for building electromagnetic coil structures as described above for FIGS. 19A-19G.

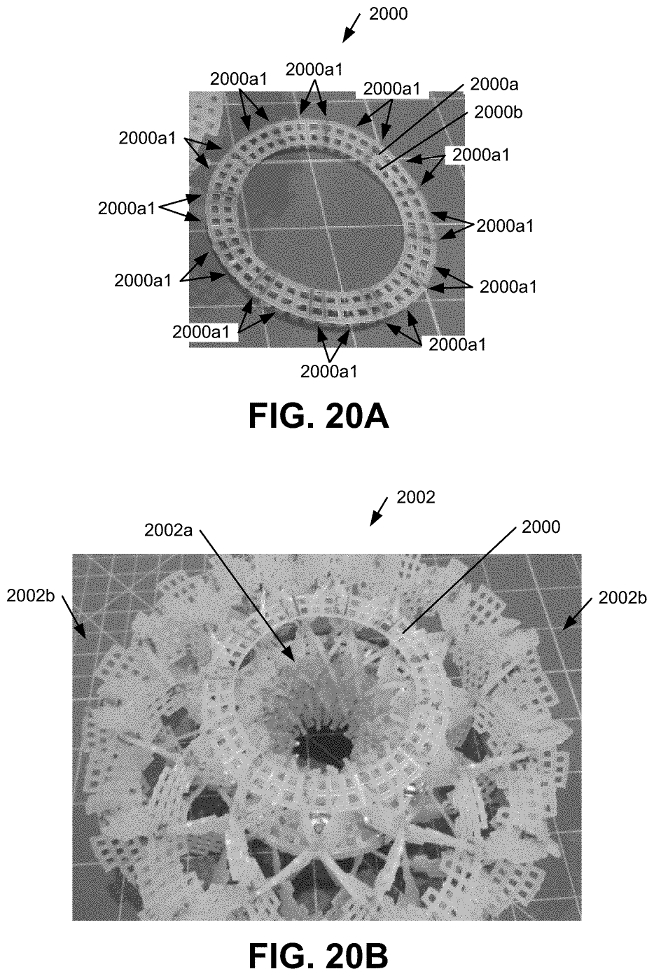

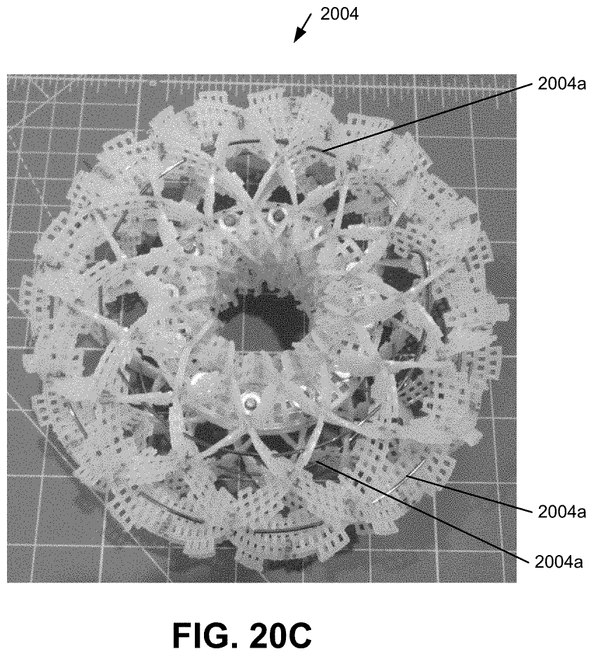

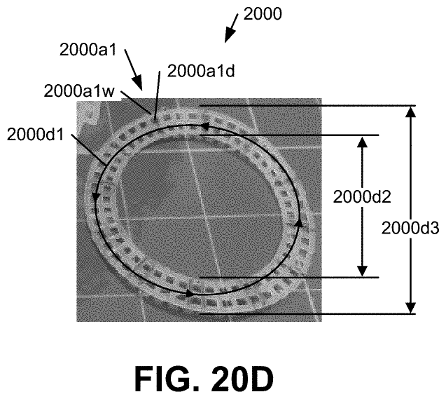

FIG. 20A illustrates an implementation of an example support ring 2000 according to the present disclosure. In some implementations, the support ring 2000 comprises a main ring 2000a and one or more adjacent additional rings 2000b surrounded by the main ring 2000a. In some implementations, the support ring 2000 is the same or similar to the support rings 600 shown in FIG. 6. In some implementations, the support ring 2000 is similar to the hub circles 1900a-f described above for FIGS. 19A-19E except that the main ring 2000a of the support ring 2000 is the outermost ring and surrounds any additional rings 2000b of the support ring 2000. In some implementations, the main ring 2000a comprises spacer unit notches 2000a1 that are the same or similar to the spacer unit notches 1900b1a of the hub circle main ring 1900b1 except that the notches 2000a1 open or face outward from the support ring 2000 since the main ring 2000a is the outermost ring.

FIG. 20B illustrates an implementation of an example electromagnetic coil structure 2002 that includes one or more support rings 2000 according to the present disclosure. In some implementations, the support ring 2000 is configured to connect to the parts 1600a, 1600b described above for FIGS. 16A and 16B, the hub 502, 1900f1,g1 described above for FIGS. 5B and 19A-19G, and other parts of the system for building electromagnetic coil structures. In some implementations, one or more of the support rings 2000 are connected to the electromagnetic coil structure 2002 along the inner circumference 2002a and/or outer circumference 2002b of the electromagnetic coil structure 2002. In some implementations, the support ring 2000 is configured to support and maintain the structure of electromagnetic coil structures 2002 built according to the present disclosure. In some implementations, the support ring 2000 is configured to support and maintain the structure of an electromagnetic coil structure 2002 when adding magnet wire to the electromagnetic coil structure 2002 to build an electromagnetic coil according to the present disclosure. For example, in some implementations, support rings 2000 connected along the inner circumference 2002a of the electromagnetic coil structure 2002 can provide stiffness to the electromagnetic coil structure 2002. In some implementations, support rings 2000 connected along the inner circumference 2002a of the electromagnetic coil structure 2002 can prevent squashing or other deformation of the electromagnetic coil structure 2002 when adding magnet wire to the electromagnetic coil structure 2002. In some implementations, support rings 2000 connected along the outer circumference 2002b of the electromagnetic coil structure 2002 can provide such support to the electromagnetic coil structure 2002 and can also maintain the positioning and prevent pull-off of magnet wire on the electromagnetic coil structure 2002 similar to the function of wire ties.

In some implementations, one or more support wires may be used along with or in substitution of the support rings 2000 to provide the same or similar functions of the support rings 2000 as described above. FIG. 20C illustrates an implementation of an example electromagnetic coil structure 2004 that includes support wire 2004a according to the present disclosure. In some implementations, the support wire helps to maintain the curvature of magnet wire in the space between P-units of the electromagnetic coil structure 2004. In some implementations, the support wire 2004a can be any suitable wire or similar material for providing such functions. In some implementations, glue or another suitable adhering agent is applied to the support wire 2004a to secure the support wire to one more parts of the electromagnetic coil structure 2004 for supporting and maintaining the positions of the parts within the electromagnetic coil structure 2004.

FIG. 20D illustrates example parameters of the support ring 2000 shown in FIG. 20A. In some implementations, the support ring 2000 comprises a flat, ring shape with a circumferential surface 2000d1 between an inner diameter 2000d2 and an outer diameter 2000d3, such as an annular ring shape. In some implementations, the support ring 2000 comprises a plurality of spacer unit notches or “connection notches” 2000a1 (described above for FIG. 20A) opening into the circumferential surface 2000d1 from the outer diameter 2000d3 and spaced apart along the outer diameter 2000d3. In some implementations, the connection notches 2000a1 have a width 2000a1w that is at least the same as the thickness of the circumferential surface 2000d1 (such as the thickness of the flat stock materials described below). In some implementations, the connection notches 2000a1 have a depth 2000a1d extending from the outer diameter 2000d3 into the circumferential surface 2000d1 that is at least the same as the thickness of the circumferential surface 2000d1. In some implementations, the connection notches 2000a1 are configured to connect to other of the plurality of parts of the system for building electromagnetic coil structures as described above for FIGS. 20A and 20B.

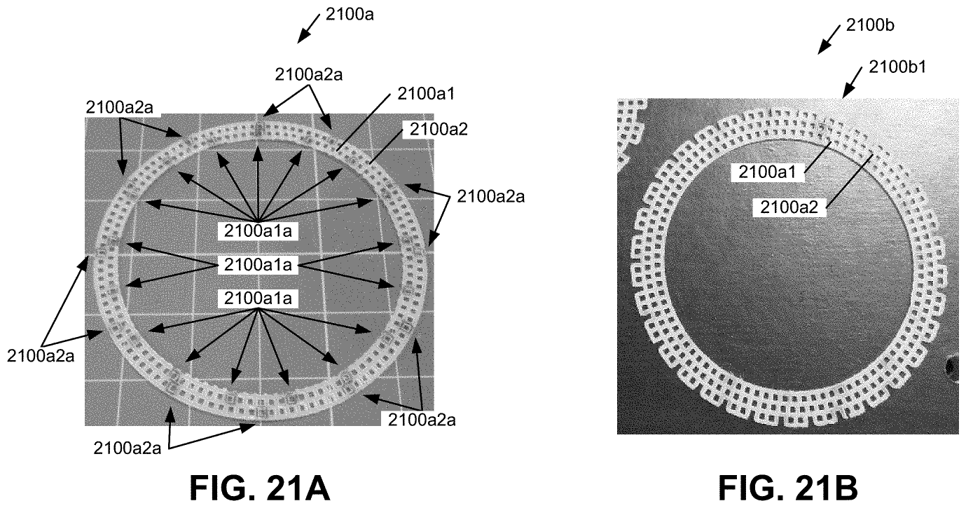

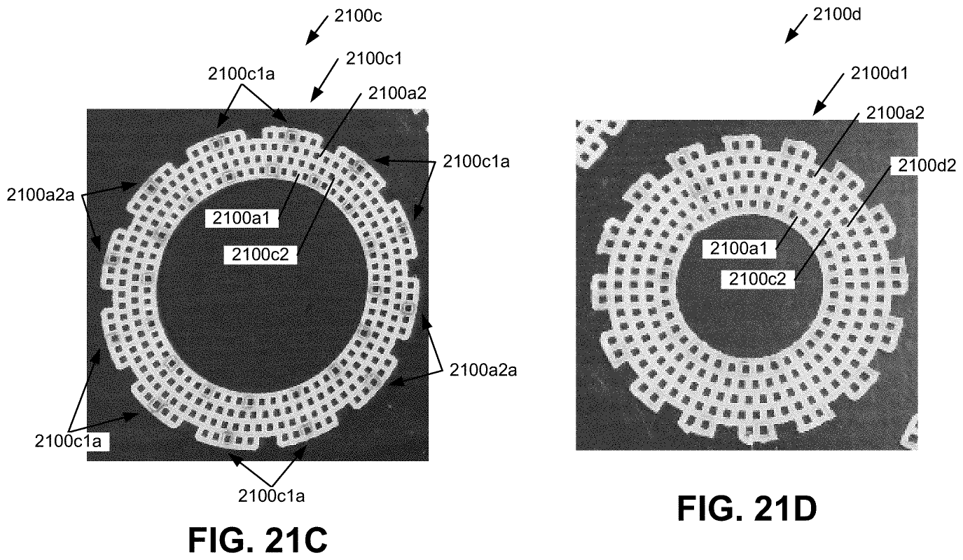

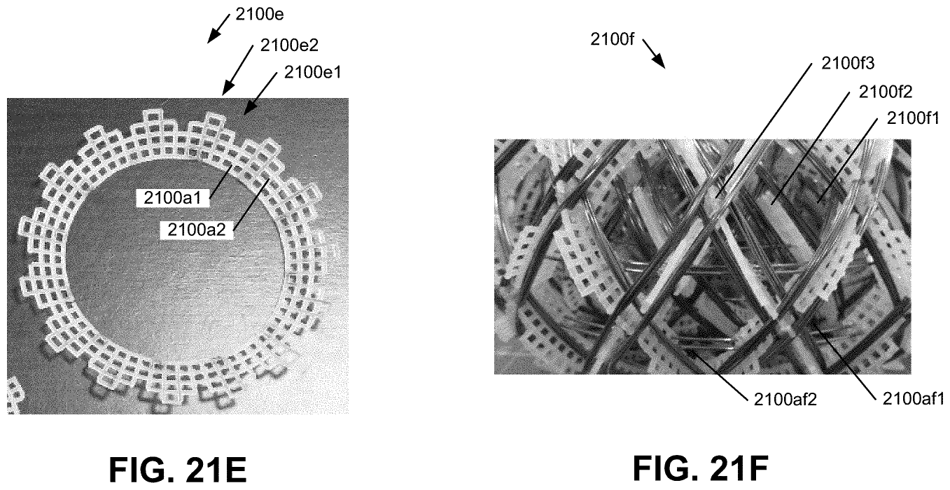

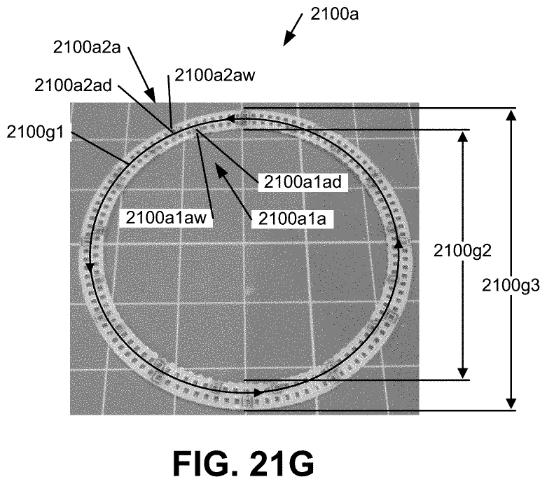

FIGS. 21A-21E illustrate implementations of example adapter rings 2100a-e according to the present disclosure. In some implementations, the adapter rings 2100a-e are the same or similar to the adapter rings 700 shown in FIG. 7. In some implementations, the adapter rings 2100a-e are similar to the hub circles 1900a-e described above for FIGS. 19A-19E and the support ring 2000 described above for FIGS. 20A and 20B. In some implementations, the adapter rings 2100a-e comprise at least an inner ring 2100a1 and an outer ring 2100a2. In some implementations, the adapter rings 2100c,d may comprise one or more additional rings 2100c2,d2 in between the inner and outer rings 2100a1,a2 as shown in FIGS. 21C and 21D. In some implementations, the adapter rings 2100b-e may comprise one or more additional units (or shoulder units) 2100b1,c1,d1,e1,e2 as shown in FIGS. 2100b-e.

In some implementations, the adapter rings 2100a-e are configured to connect two electromagnetic coil structures together. For example, in some implementations, the adapter rings 2100a-e are configured to allow a smaller electromagnetic coil structure to be used as hub for a larger electromagnetic coil structure by connecting the two electromagnetic coil structures together. In some implementations, the adapter rings 2100a-e are configured to connect two electromagnetic coil structures together having the same or “matching” T-values. In some implementations, the adapter rings 2100a-e are configured to connect two electromagnetic coil structures together having different, “unmatching”, or “mismatched” T-values. FIG. 21F illustrates an implementation of an example electromagnetic coil structure 2100f that includes adapter rings 2100af1,2 according to the present disclosure. In some implementations, the electromagnetic coil structure 2100f is multi-shelled and comprises a 12T electromagnetic coil structure 2100f1 as hub for a 17T electromagnetic coil structure 2100f2 which is a hub for a 22T electromagnetic coil structure 2100f3. In some implementations, the electromagnetic coil structures 2100f1,f2 and 2100f2,f3 are connected together by one or more adapter rings 2100af1,2.

Referring back to FIGS. 21A-21E, in some implementations, the adapter rings 2100a-e comprise units that are the same or similar to the units 1100 described above for FIGS. 11A-11C and 12. In some implementations, the number of units comprised in each ring 2100a1,a2,c2,d2 of the adapter rings 2100a-e is based on the T-values of the electromagnetic coil structures to be connected together by the adapter rings 2100a-e. In some implementations, the number of units comprised in each ring 2100a1,a2,c2,d2 of the adapter rings 2100a-e is also relative to the diameter of the electromagnetic coil structures to be connected together by the adapter rings 2100a-e. In some implementations, the number of units comprised in the outer ring 2100a2 is based on the T-value of the electromagnetic coil structure to be used as a hub. In some implementations, the number of units comprised in the inner ring 2100a1 is based on the T-value of the electromagnetic coil structure to be connected to the electromagnetic coil structure used as the hub. For example, for a complex electromagnetic coil structure comprising a 17T electromagnetic coil structure to be connected to a 12T electromagnetic coil structure to be used as a hub, using the least amount of units to maximize the available building space, the outer ring 2100a2 is designed to have one-hundred and eight (108) units, which is divisible by the 12T-value, and the inner ring 2100a1 is designed to have one-hundred and two (102) units, which is divisible by the 17T-value.

In some implementations, the inner ring 2100a1 comprises (inner) spacer unit notches 2100a1a, as shown in FIG. 21A, that are the same or similar to the spacer unit notches 1900b1a described above with respect to the hub circles 1900a-e of FIGS. 19A-19E. In some implementations, the outer ring 2100a2 comprises (outer) spacer unit notches 2100a2a, as also shown in FIG. 21A, that are the same or similar to the spacer unit notches 2000a1 described above with respect to the support ring 2000 of FIG. 20A. In some implementations, the additional units 2100c1 comprise (outer) spacer unit notches 2100c1a, as shown in FIG. 21C, that are the same or similar to the spacer unit notches 2000a1 described above with respect to the support ring 2000 of FIG. 20A.

FIG. 21G illustrates example parameters of the adapter rings 2100a-e shown in FIGS. 21A-21E, such as the adapter ring 2100a shown in FIG. 21A. In some implementations, the adapter ring 2100a comprises a flat, ring shape with a circumferential surface 2100g1 between an inner diameter 2100g2 and an outer diameter 2100g3, such as an annular ring shape. In some implementations, the adapter ring 2100a comprises a first plurality of spacer unit notches or “connection notches” 2100a1a (described above for FIGS. 21A-21E) opening into the circumferential surface 2100g1 from the inner diameter 2100g2 and spaced apart along the inner diameter 2100g2. In some implementations, the connection notches 2100a1a have a width 2100a1aw that is at least the same as the thickness of the circumferential surface 2100g1 (such as the thickness of the flat stock materials described below). In some implementations, the connection notches 2100a1a have a depth 2100a1ad extending from the inner diameter 2100g2 into the circumferential surface 2100g1 that is at least the same as the thickness of the circumferential surface 2100g1. In some implementations, the connection notches 2100a1a are configured to connect to other of the plurality of parts of the system for building electromagnetic coil structures as described above for FIGS. 21A-21F.

In some implementations, the adapter ring 2100a comprises a second plurality of spacer unit notches or “connection notches” 2100a2a (described above for FIGS. 21A-21E) opening into the circumferential surface 2100g1 from the outer diameter 2100g3 and spaced apart along the outer diameter 2100g3. In some implementations, the connection notches 2100a2a have a width 2100a2aw that is at least the same as the thickness of the circumferential surface 2100g1. In some implementations, the connection notches 2100a2a have a depth 2100a2ad extending from the outer diameter 2100g3 into the circumferential surface 2100g1 that is at least the same as the thickness of the circumferential surface 2100g1. In some implementations, the connection notches 2100a2a are configured to connect to other of the plurality of parts of the system for building electromagnetic coil structures as described above for FIGS. 21A-21F.

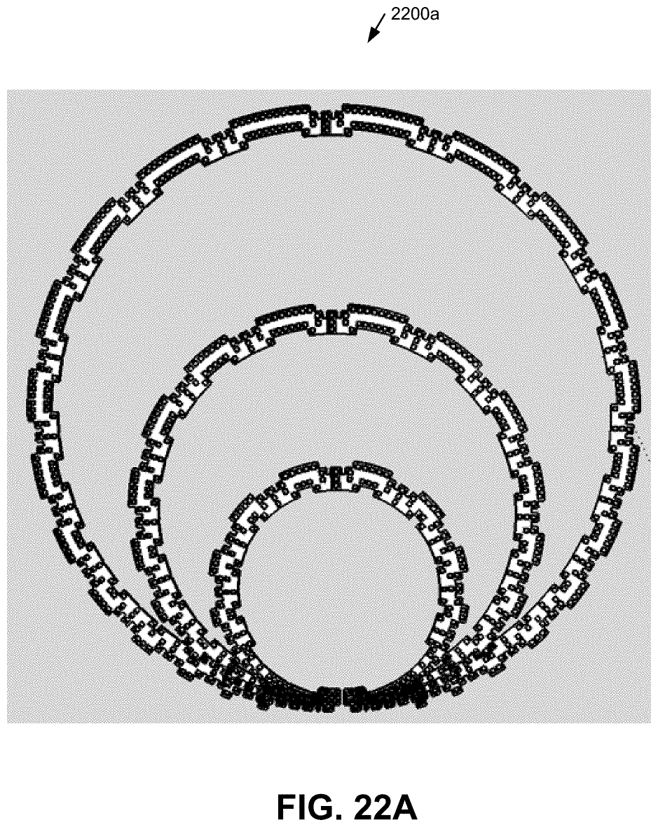

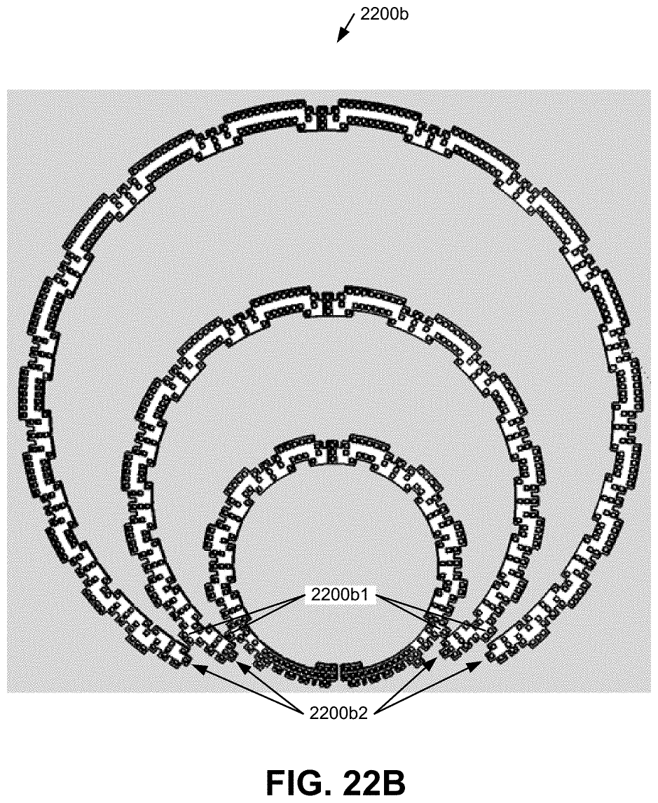

In some implementations, the P-parts 1600a, 1600b, 400a, 400b described above for FIGS. 16A, 16B, 4A, and 4B respectively are modified for use with the adapter rings 2100a-e. FIGS. 22A and 22B illustrate implementations of example P-parts 2200a, 2200b modified for use with the adapter rings 2100a-e according to the present disclosure. In some implementations, the P-parts 2200a are aligned with respect to the P1-unit of each part 2200a as shown in FIG. 22A. In some implementations, the overlapping portions of the larger aligned parts 2200b are trimmed off and discarded as shown in FIG. 22B to configure the parts 2200b to be used with the adapter rings 2100a-e in electromagnetic coil structures as described above.

In some implementations, an adapter ring 2100a-e connects to the additional units 2200b1 of the modified parts 2200 of a smaller electromagnetic coil structure that is used as a hub. In some implementations, the adapter ring 2100a-e connects to the end units 2200b2 of the modified parts 2200 of a larger electromagnetic coil structure that uses the smaller electromagnetic coil structure as the hub.

Referring back to FIGS. 8A-8C which were introduced above, in some implementations, the base circles 800 comprise units that are the same or similar to the units 1100 described above for FIGS. 11A-11C and 12. In some implementations, the base circles 800 comprise one or more rings. In some implementations, the number of units comprised in each ring of the base circles 800 is based on the T-value of the electromagnetic coil structure to be built from the parts of the system for building electromagnetic coil structures.

In some implementations, the base 802 comprises a large diameter, large width multi-ring base circle 800a and one or more additional base circles 800b-d comprising varying smaller diameters, widths, and number of rings as shown in FIGS. 8B and 8C. In some implementations, the base circles 800a-d composing the base 802 are concentrically aligned. In some implementations, as discussed further below, the base 802 is configured to support one or more dividers of an electromagnetic coil structure. In some implementations, a plurality of the additional base circles 800b-d are stacked vertically to one or more heights. In some implementations, the additional base circles 800b-d stacked to varying heights within the structure of the base 802 provide added support to parts of an electromagnetic coil structure supported by the base 802. In some implementations, the additional base circles 800b-d are printed or otherwise built to the varying heights instead of stacked. In some implementations, the one or more base circles 800a-d are connected to form the base 802 by one or more pins 802a or similar structures connected through the unit openings or other openings in the base circles 800a-d as shown in FIGS. 8B and 8C. In some implementations, the one or more base circles 800a-d are connected to form the base 802 by glue or another suitable adhering agent. In some implementations, the one or more base circles 800a-d are connected in any other suitable way to form the base 802.

In some implementations, the additional base circles 800b-d can also form a top hub 804 that is configured to support one or more dividers 900 of an electromagnetic coil structure along with the base 802, as discussed below for FIGS. 9A-9F. In some implementations, the additional base circles 800b-d that form a top hub 804 are concentrically aligned. In some implementations, the additional base circles 800b-d that form a top hub 804 are stacked to varying heights similar to the additional base circles 800b-d that form the base 802. In some implementations, the additional base circles 800b-d that form a top hub 804 are connected similar to the base circles 800b-d that form a hub 802, such as by one or more pins 802a, glue, or any other suitable manner. In some implementations, the top hub 804 can comprise one or more of the base circles 800a-d configured the same or similar to the base 802.

FIG. 8D illustrates example parameters of the base circles 800a-d shown in FIGS. 8A-8C. In some implementations, the base circles 800a-d comprises a flat, ring shape with a circumferential surface 800a1-d1 between an inner diameter 800a2-d2 and an outer diameter 800a3-d3, such as an annular ring shape.

In some implementations, the base circles 800a-d are configured to connect to other of the plurality of base circles 800a-d to form a base 802, as discussed above. In some implementations, the base 802 comprises at least a second of the plurality of base circles 800b-d concentrically aligned and connected on top of a first of the plurality of base circles 800a. In some implementations, the outer diameter 800a3 of the first base circle 800a is greater than the outer diameter 800b3-d3 of the second base circle 800b-d. In some implementations, the inner diameter 800b2-d2 of the second base circle 800b-d is at least the same as the inner diameter 800a2 of the first base circle 800a.

Referring back to FIGS. 9A-9F which were introduced above, in some implementations, the dividers 900 are planar-panel shaped. In some implementations, the dividers 900 are any other suitable shape. In some implementations, the dividers 900 comprise units that are the same or similar to the units 1100 described above for FIGS. 11A-11C and 12. In some implementations, the number of units comprised in the dividers 900 is based on the T-value and the P-value of the electromagnetic coil structure to be built. For example, in some implementations, for a single-phase 12T:17P electromagnetic coil structure, the number of units of the dividers 900 is configured to 12T:17P. In some implementations, for a three-phase 12T:17P electromagnetic coil structure, the number of units of the dividers 900 is configured to 36T:51P, which is physically larger than for the single-phase structure.

In some implementations, the dividers 900 comprise one or more openings 900a as shown in FIG. 9A. In some implementations, the openings 900a are configured to hold within or receive therethrough one or more wraps of magnet wire for building an electromagnetic coil. In some implementations, the openings 900a are configured to connect the dividers to other parts of an electromagnetic coil structure built according to the present disclosure.

In some implementations, the dividers 900 are configured to connect to a base 802 as shown in FIGS. 9B-9F. In some implementations, the dividers 900 are configured to be supported in a vertical position by the base 802. In some implementations, the dividers 900 are configured to connect to a top hub 804. In some implementations, the dividers 900 are configured to be supported in the vertical position by the top hub 804.

In some implementations, the dividers 900 comprise one or more notches 900b as shown in FIG. 9A. In some implementations, the notches 900b are openings extending one or more units in length and width from one or more edges 900c of the dividers 900. In some implementations, the notches 900b are configured to mate to the base 802 and top hub 804 connected to the dividers 900. In some implementations, the length and width of the notches 900b corresponds respectively to the length and width of the stacked additional base circles 800b-d of the base 802 and top hub 804 described above for FIGS. 8B and 8C.

In some implementations, the dividers 900 are configured to connect to one or more support rings 600. In some implementations, the dividers 900 are configured to be supported in the vertical position by the one or more support rings 600. In some implementations, one or more of the support rings 600 connected to the dividers 900 are stacked to a desired height. In some implementations, the one or more support rings 600 may be connected to the dividers 900 at different vertical positions along the dividers 900. In some implementations, the one or more support rings 600 may be connected to the dividers 900 at different vertical positions based on an increased vertical length of the dividers 900 extending from the connection of the dividers 900 to the base 802. In some implementations, the dividers 900 comprise one or more openings 900a through which the support rings can be positioned to connect to the dividers 900. In some implementations, the support rings 600 may be divided into pieces that are connected together through the openings 900a in the dividers. In some implementations, the support rings 600 may be divided into pieces based on the T-value of the electromagnetic coil structure to be built.

In some implementations, the dividers 900 may be further supported by one or more vertical supports 910 as shown in FIGS. 9E and 9F. For example, in some implementations, dividers 900 that are much longer than wide may be further supported by the one or more vertical supports 910. In some implementations, the vertical supports 910 comprise an elongated rod. In some implementations, the vertical supports 910 comprise any other suitable elongated structure that can support the dividers 900. In some implementations, the vertical supports 910 are configured to support the dividers 900 in a vertical position. In some implementations, the vertical supports 910 position adjacent to one or more vertical surfaces of the dividers 900. In some implementations, the vertical supports 910 connect to the base 802 and the top hub 804. In some implementations, the vertical supports 910 connect to the support rings 600. In some implementations, the vertical supports 910 support and maintain the structure of electromagnetic coil structures comprising dividers 900 built according to the present disclosure as shown in FIGS. 9E and 9F.

In some implementations, the dividers 900 are configured to connect to one or more hubs 502, 1900f1,g1 as shown in FIG. 9D which comprise one or more hub circles 500a as discussed above for FIGS. 5A, 5B, and 19A-19E. In some implementations, the hubs 502, 1900f1,g1 connect to the dividers 900 at, around, and/or through the openings 900a in the dividers 900. In some implementations, the hubs 502, 1900f1,g1 connected to the dividers 900 may hold, support, or route one or more wraps of magnet wire for building an electromagnetic coil.

In some implementations, the dividers 900 are also referred to as “T-parts” or “T-dividers” since the design of the dividers 900 is based on the T-value of the electromagnetic coil structure to be built.

FIG. 9G illustrates example parameters of the dividers 900 shown in FIGS. 9A-9F. In some implementations, the divider 900 comprises a flat, planar panel shape with a vertical length 900g1 and a horizontal width 900g2. In some implementations, as discussed above, the divider 900 comprises at least one opening 900a through the divider configured to connect to other of the plurality of parts or to receive magnet wire through the opening 900 to build electromagnetic coils.

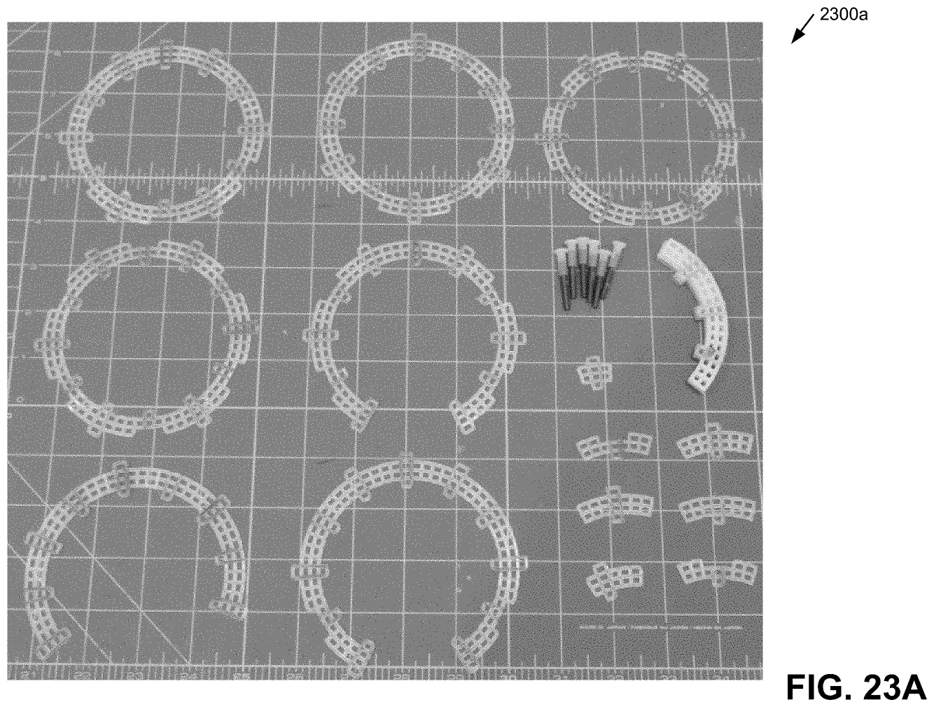

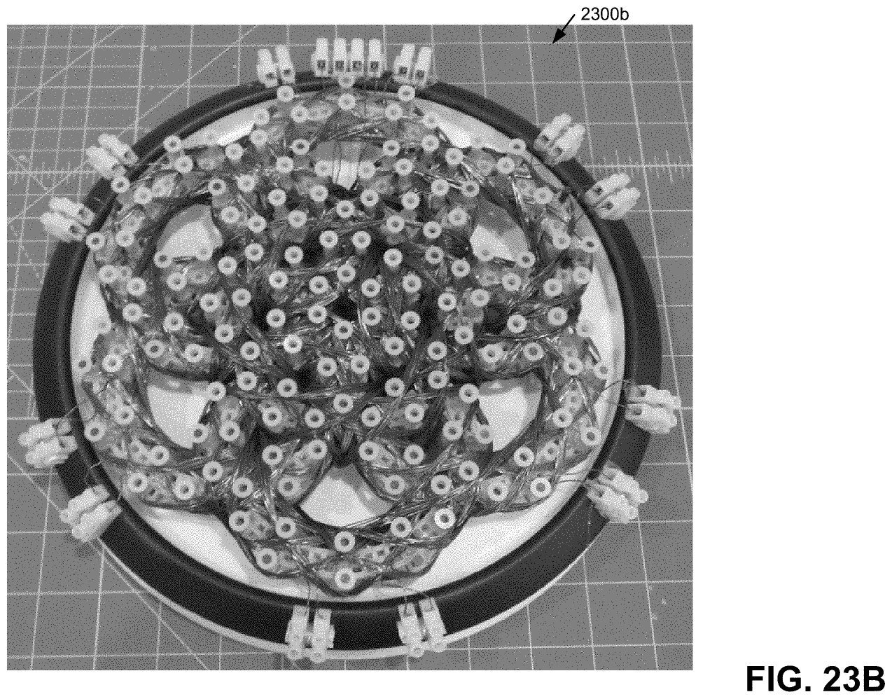

In some implementations, various parts of the system for building electromagnetic coil structures can be customized and combined to build specialized electromagnetic coil structures. For example, FIGS. 23A and 23B illustrate implementations of example customized parts 2300a and an example coplanar multi-coil electromagnetic coil structure 2300b built with the customized parts 2300a according to the present disclosure. In some implementations, the customized parts 2300a comprise customized support rings 600, 2000 and hub circles 500a, 1900a-e. In some implementations, the coplanar multi-coil electromagnetic coil structure 2300b comprises seven (7) individually wrapped coils occupying the same plane that are built on the electromagnetic coil structure 2300b.

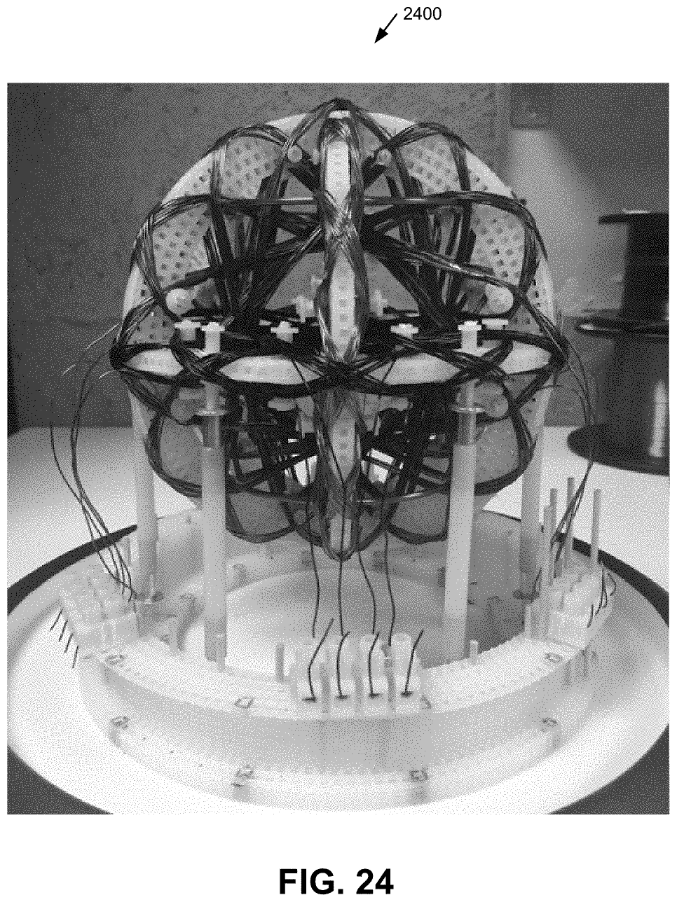

As another example, FIG. 24 illustrates an implementation of an example multi-axis electromagnetic coil structure 2400 built with customized parts according to the present disclosure. In some implementations, the customized parts comprise one or more base circles 800, support rings 600, 2000, and vertical supports. In some implementations, the multi-axis electromagnetic coil structure 2400 comprises four independent electromagnetic coils built on the electromagnetic coil structure 2400.

In some implementations, the parts of the system for building electromagnetic coil structures are described above and shown in figures as comprising one or more openings through the parts, such as the unit sized openings or units 1100 described above for FIGS. 11A-11C and 12. However, in some implementations, the parts can at the least comprise openings through the parts to connect to one or more of the same or other parts to form an electromagnetic coil structure or to hold within or receive therethrough one or more wraps of magnet wire for building an electromagnetic coil on the electromagnetic coil structure, as described above. In some implementations, the material used to make the parts may already comprise the openings throughout the material, such as with plastic canvas. In some implementations, the material may be fabricated, such as by three-dimensional (3D) printing or other suitable process, to comprise the least or more of the openings corresponding to the electromagnetic coil structure to be built. In some implementations, the material may be obtained or fabricated to comprise more than the least of the openings so that the parts can be flexibly used to build various designs of electromagnetic coil structures according to the present disclosure.

In some implementations, the parts of the system for building electromagnetic coil structures can be produced from a variety of flat stock materials. In some implementations, such flat stock materials comprise overall flexibility with edge rigidity. For example, in some implementations, such flat stock materials may comprise plastic canvas. In some implementations, the system for building electromagnetic coil structures is composed of any other suitable materials.

In some implementations, the thickness of such flat stock materials is based on the overall desired size of the electromagnetic coil to be built on the electromagnetic coil structure. For example, in some implementations, the thickness of such flat stock materials can be one-sixteenth of an inch ( 1/16″) for a smaller sized electromagnetic coil and scaled thicker relative to a larger sized electromagnetic coil. In some implementations, the thickness of such flat stock materials is relative the unit size of the parts to be built from the materials. In some implementations, such flat stock materials can be any other suitable thickness for building electromagnetic coil structures according to the present disclosure.

In some implementations, the parts of the system for building electromagnetic coil structures and/or the materials used to make the parts can be fabricated by laser cutting, such as laser cutting of acrylic. In some implementations, the parts of the system for building electromagnetic coil structures and/or the materials used to make the parts can be fabricated by injection molding. In some implementations, the parts of the system for building electromagnetic coil structures and/or the materials used to make the parts can be fabricated by computer numerical control (CNC) cutting. In some implementations, the parts of the system for building electromagnetic coil structures and/or the materials used to make the parts can be fabricated by any other suitable process.

In some implementations, the system for building electromagnetic coil structures comprises any other suitable dimensions.

In some implementations, the system for building electromagnetic coil structures can have any suitable appearance.

In some implementations, a method for building electromagnetic coil structures according to the present disclosure having a T-value that is greater than the P-value, such as shown in FIGS. 3A and 3B, comprises connecting one or more of the above-described top parts 1600a, bottom parts 1600b, hub circles 500a, 1900a-e or adapter rings 700, 2100a-e, and support rings 600, 2000.

In some implementations, connecting the top parts 1600a and bottom parts 1600b, described above for FIGS. 16A and 16B, comprises connecting a plurality of each of the top parts 1600a and bottom parts 1600b together. In some implementations, the plurality is equal to the T-value of the electromagnetic coil structure to be built. For example, in some implementations, to build a 12T:7P electromagnetic coil structure, the method comprises connecting twelve (12) each of the top parts 1600a and bottom parts 1600b.

In some implementations, connecting the top parts 1600a and bottom parts 1600b comprises connecting each of the top parts 1600a to one of the bottom parts 1600. In some implementations, connecting each of the top parts 1600a to one of the bottom parts 1600 comprises pushing together the P1 P-unit notch 1400a4 of the top part 1600a and the P1 P-unit notch 1400b4 of the bottom part 1600b for each of the parts 1600a, 1600b to securely connect each of the respective parts 1600a, 1600b together to form a first part grouping 400c such as shown in FIG. 4C. In some implementations, connecting together the plurality of parts 1600a, 1600b forms a plurality of first part groupings 400c.

In some implementations, connecting the top parts 1600a and bottom parts 1600b comprises connecting together two each of the plurality of first part groupings 400c. In some implementations, connecting together two each of the plurality of first part groupings 400c comprises pushing together the P-unit notches 1400a4, 1400b4 of one of the two first part groupings 400c and the P-unit notches 1400a4, 1400b4 of the other of the two first part groupings 400c to securely connect each of the respective two first part groupings 400c together to form a second part grouping 1600c such as shown in FIG. 16C. In some implementations, the P-unit notches 1400a4, 1400b4 pushed together are successively adjacent to the P1 P-unit notches 1400a4, 1400b4 on each side of the P1 P-unit notches 1400a4, 1400b4. For example, in some implementations, when building a 12T:7P electromagnetic coil structure, the P2 and P14 P-unit notches 1400a4, 1400b4 of the one of the first part groupings 400c and the P2 and P14 P-unit notches 1400a4, 1400b4 of the other of the first part groupings 400c are pushed together to form a second part grouping 1600c. In some implementations, connecting together the plurality of first part groupings 400c forms a plurality of second part groupings 1600c.

In some implementations, connecting the top parts 1600a and bottom parts 1600b comprises connecting together two each of the plurality of second part groupings 1600c. In some implementations, connecting together two each of the plurality of second part groupings 1600c comprises pushing together the P-unit notches 1400a4, 1400b4 of one of the two second part groupings 1600c and the P-unit notches 1400a4, 1400b4 of the other of the two second part groupings 1600c to securely connect each of the respective two second part groupings 1600c together to form a third part grouping 1600d such as shown in FIG. 16D. In some implementations, the P-unit notches 1400a4, 1400b4 pushed together are successively adjacent to the previously pushed together P-unit notches 1400a4, 1400b4. For example, in some implementations, when building a 12T:7P electromagnetic coil structure, the P3, P4, P13, and P12 P-unit notches 1400a4, 1400b4 of the one of the second part groupings 1600c and the P3, P4, P13, and P12 P-unit notches 1400a4, 1400b4 of the other of the second part groupings 1600c are pushed together to form a third part grouping 1600d. In some implementations, connecting together the plurality of second part groupings 1600c forms a plurality third part groupings 1600d.

In some implementations, connecting the top parts 1600a and bottom parts 1600b comprises continuing to successively connect increasing-size part groupings together by pushing together the respective P-unit notches 1400a4, 1400b4 as described above until all of the P-unit notches 1400a4, 1400b4 of all of the connected top parts 1600a and bottom parts 1600b are pushed together. For example, in some implementations, when building a 12T:7P electromagnetic coil structure, the part grouping 1600e shown in FIG. 16E is formed by continuing to successively connect the part groupings together and finally the electromagnetic coil structure 1600f shown in FIG. 16F is formed.

In some implementations, connecting the top parts 1600a and bottom parts 1600b alternately comprises successively connecting the first part groupings together by pushing together the respective P-unit notches 1400a4, 1400b4 as described above until all of the P-unit notches 1400a4, 1400b4 of all of the connected top parts 1600a and bottom parts 1600b are pushed together.

In some implementations, connecting the hub circles 500a, 1900a-e, described above for FIGS. 5A and 19A-19E, comprises connecting the hub circles 500a, 1900a-e to form a hub 502, 1900f1,g1 described above for FIGS. 5B and 19F-19G. In some implementations, connecting the hub circles 500a, 1900a-e to form a hub 502, 1900f1,g1 comprises connecting two or more of the hub circles 500a, 1900a-e with hub parts 500b. For example, in some implementations, connecting the hub circles 500a, 1900a-e to form a hub 502, 1900f1,g1 comprises connecting one hub circle 500a, 1900a-e concentrically aligned to another hub circle 500a, 1900a-e spaced apart between two or more spacers 500b2 on two or more threaded rods 500b1 secured together with two or more washers 500b3 and two or more locknuts 500b4.

In some implementations, connecting the hub circles 500a, 1900a-e further comprises connecting the hub 502, 1900f1,g1 to one or more of the part groupings 400c, 1600a-f of the top and bottom parts 1600a, 1600b. In some implementations, connecting the hub 502, 1900f1,g1 to one or more of the part groupings 400c, 1600a-f of the top and bottom parts 1600a, 1600b comprises pushing together the end P-unit notches 1400a4, 1400b4 of the parts 1600a, 1600b of the electromagnetic coil structure 1600f and the spacer unit notches 1900b1a of the hub 502, 1900f1,g1 to securely connect the hub 502, 1900f1,g1 to the electromagnetic coil structure 1600f to form another electromagnetic coil structure 1900f,g as shown in FIGS. 19F and 19G. For example, in some implementations, when building a 12T:7P electromagnetic coil structure, connecting the hub 502, 1900f1,g1 to one or more of the part groupings 400c, 1600a-f of the top and bottom parts 1600a, 1600b comprises pushing together the P7 P-unit notches 1400a4, 1400b4 of the electromagnetic coil structure 1600f and the spacer unit notches 1900b1a of the hub 502, 1900f1,g1.

In some implementations, connecting the adapter rings 700, 2100a-e, described above for FIGS. 7 and 21A-21E, comprises connecting an adapter ring 700, 2100a-e to a first electromagnetic coil structure 2100f1 to be used as a hub (similar in function to the above described hub 502, 1900f1,g1 for FIGS. 5B and 19F-19G) for a second electromagnetic coil structure 2100f2. In some implementations, connecting the adapter rings 700, 2100a-e comprises connecting the adapter ring 700, 2100a-e to the second electromagnetic coil structure 2100f2 so that the second electromagnetic coil structure 2100f2 is positioned around the first electromagnetic coil structure 2100f1 with the adapter ring 700, 2100a-e connected in between as shown in FIG. 21F.

In some implementations, connecting the adapter ring 700, 2100a-e to the first electromagnetic coil structure 2100f1 comprises pushing together the inner spacer unit notches 2100a1a of the adapter ring 700, 2100a-e and the additional units 1400a3, 1400b3 of the parts 1600a, 1600b of the first electromagnetic coil structure 2100f1 to securely connect the adapter ring 700, 2100a-e to the first electromagnetic coil structure 2100f1. In some implementations, connecting the adapter ring 700, 2100a-e to the second electromagnetic coil structure 2100f2 comprises pushing together the outer spacer unit notches 2100a2a of the adapter ring 700, 2100a-e and the end P-unit notches 1400a4, 1400b4 of the parts 1600a, 1600b of the second electromagnetic coil structure 2100f2 to securely connect the adapter ring 700, 2100a-e to the second electromagnetic coil structure 2100f2.

In some implementations, connecting the adapter rings 700, 2100a-e further comprises connecting one or more additional adapter rings 700, 2100a-e between one or more additional electromagnetic coil structures respectively in additional configurations in which one electromagnetic coil structure is used as a hub for another electromagnetic coil structure. For example, in some implementations, connecting the adapter rings 700, 2100a-e further comprises connecting another adapter ring 700, 2100a-e between the second electromagnetic coil structure 2100f2 and a third electromagnetic coil structure 2100f3 to use the second electromagnetic coil structure 2100f2 as a hub for the third electromagnetic coil structure 2100f3 as shown in FIG. 21F. In some implementations, connecting the other adapter ring 700, 2100a-e between the second electromagnetic coil structure 2100f2 and the third electromagnetic coil structure 2100f3 is done the same or similar to connecting the adapter ring 700, 2100a-e between the first electromagnetic coil structure 2100f1 and the second electromagnetic coil structure 2100f2 as described above.

In some implementations, connecting the support rings 600, 2000, described above for FIGS. 20A-20C, comprises connecting one or more of the support rings 2000 to an electromagnetic coil structure 2002 as shown in FIG. 20B. In some implementations, connecting the one or more support rings 2000 to the electromagnetic coil structure 2002 comprises connecting the support rings 2000 to the electromagnetic coil structure 2002 within the inner circumference 2002a of the electromagnetic coil structure 2002. In some implementations, connecting the one or more support rings 2000 to the electromagnetic coil structure 2002 comprises pushing together the spacer unit notches 2000a1 of the support ring 2000 and the additional units 1400a3, 1400b3 of the parts 1600a, 1600b of the electromagnetic coil structure 2002 to securely connect the support ring 2000 to the electromagnetic coil structure 2002.

In some implementations, the method for building electromagnetic coil structures further comprises adding one or more wraps of magnet wire to one or more of the above described electromagnetic coil structures to build an electromagnetic coil on the electromagnetic coil structure such as shown in FIGS. 19G and 21F. In some implementations, adding one or more wraps of magnet wire to one or more of the electromagnetic coil structures comprises adding one or more wraps of magnet wire on or through one or more spacer unit notches 1400a5, 1400b5 of the parts 1600a, 1600b of the electromagnetic coil structures. In some implementations, adding one or more wraps of magnet wire to one or more of the electromagnetic coil structures comprises adding one or more wraps of magnet wire on or through one or more hubs 502, 1900f1,g1 of the electromagnetic coil structures.

In some implementations, a method for building electromagnetic coil structures according to the present disclosure having a P-value that is greater than the T-value, such as shown in FIGS. 9D-9F, comprises connecting one or more of the above-described base circles 800 and dividers 900 to build an electromagnetic coil structure, and in some implementations further comprises connecting one or more of the above-described support rings 600, 2000 and/or hub circles 500a, 1900a-e.

In some implementations, connecting the base circles 800, described above for FIGS. 8A-8C, comprises connecting one or more of the base circles 800 to form a base 802, also described above for FIGS. 8A-8C. In some implementations, connecting the base circles 800 to form a base 802 comprises connecting a large diameter, large width multi-ring base circle 800a and one or more additional base circles 800b-d comprising varying smaller diameters, widths, and number of rings concentrically aligned as shown in FIGS. 8B and 8C. In some implementations, connecting the base circles 800a-d to form the base 802 comprises connecting the base circles 800a-d together with one or more pins 802a or similar structures pushed through one or more openings in the base circles 800a-d. In some implementations, connecting the base circles 800a-d to form the base 802 comprises connecting the base circles 800a-d with glue or another suitable adhering agent. In some implementations, connecting the base circles 800a-d to form the base 802 comprises connecting the base circles 800a-d in any other suitable way to form the base 802. In some implementations, connecting the base circles 800a-d to form the base 802 comprises stacking a plurality of the additional base circles 800b-d vertically to one or more heights to provide added support to an electromagnetic coil structure supported by the base 802.

In some implementations, connecting the base circles 800 comprises connecting one or more of the additional base circles 800b-d concentrically aligned to form a top hub 804, described above for FIGS. 8A-8C and 9A-9F. In some implementations, connecting one or more of the additional base circles 800b-d to form a top hub 804 comprises connecting the additional base circles 800b-d together with one or more pins 802a or similar structures pushed through one or more openings in the additional base circles 800b-d. In some implementations, connecting one or more of the additional base circles 800b-d to form a top hub 804 comprises connecting the additional base circles 800b-d together with glue or in any other suitable way to form the top hub 804. In some implementations, connecting the additional base circles 800b-d to form a top hub 804 comprises stacking a plurality of the additional base circles 800b-d vertically to one or more heights to provide added support to an electromagnetic coil structure supported by the top hub 804.

In some implementations, connecting the dividers 900, described above for FIGS. 9A-9F, comprises connecting one or more of the dividers 900 to a base 802, described above and for FIGS. 8A-8C. In some implementations, connecting the dividers 900 to a base 802 comprises connecting one or more of the dividers 900 in a vertical position to the base 802 as shown in FIGS. 9B-9F. In some implementations, connecting the dividers 900 to a base 802 comprises connecting one or more of the dividers 900 to the base 802 to support the divider 900 in the vertical position. In some implementations, connecting the dividers 900 to a base 802 comprises mating one or more notches 900b of the dividers 900 to the stacked additional base circles 800b-d of the base 802.

In some implementations, connecting the dividers 900 comprises connecting one or more of the dividers 900 to a top hub 804, described above and for FIGS. 8A-8C and 9A-9F. In some implementations, connecting the dividers 900 to a top hub 804 comprises connecting the top hub 804 to the top of one or more vertically positioned dividers 900 as shown in FIGS. 9B-9F. In some implementations, connecting the dividers 900 to a top hub 804 comprises connecting the top hub 804 to the dividers 900 to support the dividers 900 in the vertical position. In some implementations, connecting the dividers 900 to a top hub 804 comprises mating the stacked additional base circles 800b-d of the top hub 804 to one or more notches 900b of the dividers 900.

In some implementations, connecting the dividers 900 further comprises connecting one or more vertical supports 910 to support the dividers 900 as shown in FIGS. 9E and 9F. In some implementations, connecting one or more vertical supports 910 to support the dividers 900 comprises positioning the one or more vertical supports 910 adjacent to one or more vertical surfaces of the dividers 900. In some implementations, connecting one or more vertical supports 910 to support the dividers 900 comprises connecting the one or more vertical supports 910 to a base 802 and a top hub 804 that are connected to the dividers 900. In some implementations, connecting one or more vertical supports 910 to support the dividers 900 comprises connecting the one or more vertical supports 910 to one or more support rings 600 that are connected to the dividers 900.

In some implementations, the method for building electromagnetic coil structures further comprises adding one or more wraps of magnet wire to one or more of the above described electromagnetic coil structures to build an electromagnetic coil on the electromagnetic coil structure such as shown in FIGS. 9D-9F. In some implementations, adding one or more wraps of magnet wire to one or more of the electromagnetic coil structures comprises adding one or more wraps of magnet wire on or through one or more openings 900a in the dividers 900 of the electromagnetic coil structures. In some implementations, adding one or more wraps of magnet wire to one or more of the electromagnetic coil structures comprises adding one or more wraps of magnet wire on or through one or more hubs 502, 1900f1,g1 connected to the dividers 900 of the electromagnetic coil structures.

The figures, including photographs and drawings, comprised herewith may represent one or more implementations of the system and method for building electromagnetic coil structures.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A system for building electromagnetic coil structures comprising a plurality of parts, the plurality of parts comprising a combination of any of one or more of a top part, one or more of a bottom part, one or more of a hub circle, one or more of a support ring, one or more of an adapter ring, one or more of a base circle, or one or more of a divider, wherein:
the top part comprises: a flat, ring shape with a circumferential surface between an inner diameter and an outer diameter; a gap in the circumferential surface wherein the gap extends from the inner diameter to the outer diameter and has a width that is at most the difference between the outer diameter and the inner diameter; a plurality of connection notches opening into the circumferential surface from the inner diameter, spaced apart along the inner diameter, having a width that is at least the same as the thickness of the circumferential surface, having a depth extending from the inner diameter into the circumferential surface that is at least half of the difference between the outer diameter and the inner diameter, and configured to connect to other of the plurality of parts; a plurality of wire notches opening into the circumferential surface from the outer diameter, spaced apart along the outer diameter, aligned adjacent to each side of the connection notches, having a width that is at least the same as the thickness of the circumferential surface, having a depth extending from the outer diameter into the circumferential surface that is at least the same as the thickness of the circumferential surface, and configured to receive magnet wire within the wire notches to build electromagnetic coils; a plurality of inward extensions of the circumferential surface extending from the inner diameter, spaced apart along the inner diameter aligned between the connection notches, having a length extending from the inner diameter of at least the thickness of the circumferential surface, having a width of at least the thickness of the circumferential surface, and having at least one opening through each inward extension configured to connect to other of the plurality of parts; and a plurality of outward extensions of the circumferential surface extending from the outer diameter, spaced apart along the outer diameter aligned between the wire notches, having a length extending from the outer diameter of at least the thickness of the circumferential surface, having a width of at least the thickness of the circumferential surface, and having at least one opening through each outward extension configured to connect to other of the plurality of parts;
the bottom part comprises: a flat, ring shape with a circumferential surface between an inner diameter and an outer diameter; a gap in the circumferential surface wherein the gap extends from the inner diameter to the outer diameter and has a width that is at most the difference between the outer diameter and the inner diameter; a plurality of connection notches opening into the circumferential surface from the outer diameter, spaced apart along the outer diameter, having a width that is at least the same as the thickness of the circumferential surface, having a depth extending from the outer diameter into the circumferential surface that is at least half of the difference between the outer diameter and the inner diameter, and configured to connect to other of the plurality of parts; a plurality of wire notches opening into the circumferential surface from the outer diameter, spaced apart along the outer diameter adjacent to each side of the connection notches, having a width that is at least the same as the thickness of the circumferential surface, having a depth extending from the outer diameter into the circumferential surface that is at least the same as the thickness of the circumferential surface, and configured to receive magnet wire within the wire notches to build electromagnetic coils; a plurality of inward extensions of the circumferential surface extending from and spaced apart along the inner diameter, having a length extending from the inner diameter of at least the thickness of the circumferential surface, having a width of at least the thickness of the circumferential surface, and having at least one opening through each inward extension configured to connect to other of the plurality of parts; and a plurality of outward extensions of the circumferential surface extending from the outer diameter, spaced apart along the outer diameter aligned between the wire notches, having a length extending from the outer diameter of at least the thickness of the circumferential surface, having a width of at least the thickness of the circumferential surface, and having at least one opening through each outward extension configured to connect to other of the plurality of parts;
the hub circle comprises: a flat, ring shape with a circumferential surface between an inner diameter and an outer diameter; and a plurality of connection notches opening into the circumferential surface from the inner diameter, spaced apart along the inner diameter, having a width that is at least the same as the thickness of the circumferential surface, having a depth extending from the inner diameter into the circumferential surface that is at least the same as the thickness of the circumferential surface, and configured to connect to other of the plurality of parts;
the support ring comprises: a flat, ring shape with a circumferential surface between an inner diameter and an outer diameter; and a plurality of connection notches opening into the circumferential surface from the outer diameter, spaced apart along the outer diameter, having a width that is at least the same as the thickness of the circumferential surface, having a depth extending from the outer diameter into the circumferential surface that is at least the same as the thickness of the circumferential surface, and configured to connect to other of the plurality of parts;
the adapter ring comprises: a flat, ring shape with a circumferential surface between an inner diameter and an outer diameter; a first plurality of connection notches opening into the circumferential surface from the inner diameter, spaced apart along the inner diameter, having a width that is at least the same as the thickness of the circumferential surface, having a depth extending from the inner diameter into the circumferential surface that is at least the same as the thickness of the circumferential surface, and configured to connect to other of the plurality of parts; and a second plurality of connection notches opening into the circumferential surface from the outer diameter, spaced apart along the outer diameter, having a width that is at least the same as the thickness of the circumferential surface, having a depth extending from the outer diameter into the circumferential surface that is at least the same as the thickness of the circumferential surface, and configured to connect to other of the plurality of parts;
the base circle comprises a flat, ring shape with a circumferential surface between an inner diameter and an outer diameter; and
the divider comprises: a flat, planar panel shape with a vertical length and a horizontal width; and at least one opening through the divider configured to connect to other of the plurality of parts and to receive magnet wire through the opening to build electromagnetic coils.

2. The system of claim 1 wherein the top part and the bottom part are configured to connect together by pushing together one of the connection notches of the top part and one of the connection notches of the bottom part.

3. The system of claim 1 wherein the hub circle is configured to connect to another hub circle to form a hub, wherein the hub comprises the hub circle concentrically aligned and connected to the other hub circle by connecting parts comprising at least one of a threaded rod, a spacer, a washer, or a locknut.

4. The system of claim 3 wherein the hub is configured to connect to one of the top part or the bottom part by pushing together one of the connection notches of one of the hub circles of the hub and one of the connection notches of the top part or the bottom part.

5. The system of claim 3 wherein the hub and the divider are configured to connect together at the opening in the divider so that magnet wire can be received through the opening in the divider supported by at least one opening in one of the hub circles of the hub.

6. The system of claim 1 wherein the support ring is configured to connect to one of the top part or the bottom part by pushing together one of the connection notches of the support ring and the opening through one of the inward extensions of the top part or the bottom part.

7. The system of claim 1 wherein the support ring and the divider are configured to connect together to support the divider in a vertical position.

8. The system of claim 1 wherein the adapter ring is configured to connect a first one of the top part or the bottom part by pushing together one of the first plurality of connection notches of the adapter ring and the opening through one of the outward extensions of the first one of the top part or the bottom part, and the adapter ring is configured to connect a second one of the top part or the bottom part by pushing together one of the second plurality of connection notches of the adapter ring and one of the connection notches of the second one of the top part or the bottom part.

9. The system of claim 1 wherein the base circle is configured to connect to other of the plurality of base circles to form a base, wherein the base comprises at least a second of the plurality of base circles concentrically aligned and connected on top of a first of the plurality of base circles, wherein the outer diameter of the first base circle is greater than the outer diameter of the second base circle and the inner diameter of the second base circle is at least the same as the inner diameter of the first base circle.

10. The system of claim 9 wherein the base and the divider are configured to connect together at a bottom horizontal edge of the divider to support the divider in a vertical position.

11. The system of claim 1 wherein the base circle is configured to connect to a top horizontal edge of at least one of the plurality of dividers as a top hub, wherein the top hub is configured to support the divider in a vertical position.

12. The system of claim 11 wherein the top hub comprises a first of the plurality of base circles concentrically aligned and connected to at least a second of the plurality of base circles.

13. The system of claim 1 wherein the divider further comprises at least a first notch extending into the divider from a bottom horizontal edge of the divider and at least a second notch extending into the divider from a top horizontal edge of the divider, wherein the first notch and the second notch each have a length extending into the divider that is at least the same as the thickness of the divider and a width that is at least the same as the thickness of the divider, and wherein the first notch and the second notch are configured to connect to other of the plurality of parts to support the divider in a vertical position.

14. A method for building electromagnetic coil structures with the system of claim 1, the method comprising connecting at least one of the plurality of the top part, the bottom part, the hub circle, the support ring, the adapter ring, the base circle, or the divider, wherein:
connecting the top part and the bottom part comprises pushing together one of the connection notches of the top part and one of the connection notches of the bottom part;
connecting the hub circle comprises forming a hub by connecting the hub circle concentrically aligned to another hub circle with connecting parts comprising at least one of a threaded rod, a spacer, a washer, or a locknut; and
connecting the adapter ring comprises pushing together one of the first plurality of connection notches of the adapter ring and the opening through one of the outward extensions of a first one of the top part or the bottom part, and pushing together one of the second plurality of connection notches of the adapter ring and one of the connection notches of a second one of the top part or the bottom part.

15. The method of claim 14 wherein connecting the support ring comprises pushing together one of the connection notches of the support ring and the opening through one of the inward extensions of one of the top part or the bottom part; wherein connecting the support ring comprises connecting the support ring and the divider to support the divider in a vertical position; wherein connecting the hub comprises pushing together one of the connection notches of one of the hub circles of the hub and one of the connection notches of one of the top part or the bottom part; wherein connecting the hub comprises connecting the hub and the divider at the opening in the divider so that magnet wire can be received through the opening in the divider supported by at least one opening in one of the hub circles of the hub; wherein connecting the base circle comprises forming a base by concentrically aligning and connecting at least a second of the plurality of base circles on top of a first of the plurality of base circles, wherein the outer diameter of the first base circle is greater than the outer diameter of the second base circle and the inner diameter of the second base circle is at least the same as the inner diameter of the first base circle; wherein connecting the base comprises connecting the base and the divider at a bottom horizontal edge of the divider to support the divider in a vertical position; wherein connecting the base circle comprises connecting the base circle to a top horizontal edge of at least one of the plurality of dividers as a top hub to support the divider in a vertical position; and wherein connecting the base circle as a top hub comprises concentrically aligning and connecting a first of the plurality of base circles to at least a second of the plurality of base circles.

16. A system for building electromagnetic coil structures comprising at least one of a of a top part and a bottom part, wherein:
the top part comprises: a flat, ring shape with a circumferential surface between an inner diameter and an outer diameter; a gap in the circumferential surface wherein the gap extends from the inner diameter to the outer diameter and has a width that is at most the difference between the outer diameter and the inner diameter; a plurality of connection notches opening into the circumferential surface from the inner diameter, spaced apart along the inner diameter, and configured to connect to the bottom part; a plurality of wire notches opening into the circumferential surface from the outer diameter, spaced apart along the outer diameter, aligned adjacent to each side of the connection notches, and configured to receive magnet wire within the wire notches to build electromagnetic coils;
the bottom part comprises: a flat, ring shape with a circumferential surface between an inner diameter and an outer diameter; a gap in the circumferential surface wherein the gap extends from the inner diameter to the outer diameter and has a width that is at most the difference between the outer diameter and the inner diameter; a plurality of connection notches opening into the circumferential surface from the outer diameter, spaced apart along the outer diameter, and configured to connect to the top part; a plurality of wire notches opening into the circumferential surface from the outer diameter, spaced apart along the outer diameter adjacent to each side of the connection notches, and configured to receive magnet wire within the wire notches to build electromagnetic coils.

17. A method for building electromagnetic coil structures with the system of claim 16, the method comprising connecting at least one of the plurality of the top part, the bottom part, the hub circle, the support ring, the adapter ring, the base circle, or the divider, wherein:
connecting the top part and the bottom part comprises pushing together one of the connection notches of the top part and one of the connection notches of the bottom part.

18. The system of claim 16 further comprising a hub circle wherein:
the hub circle comprises: a flat, ring shape with a circumferential surface between an inner diameter and an outer diameter; and a plurality of connection notches opening into the circumferential surface from the inner diameter, spaced apart along the inner diameter, and configured to connect to connection notches of the top part or the bottom part.

19. The system of claim 16 wherein:
the top part further comprises a plurality of inward extensions of the circumferential surface extending from the inner diameter, spaced apart along the inner diameter aligned between the connection notches, having at least one opening through each inward extension configured to connect to a support ring;
the bottom part further comprises a plurality of inward extensions of the circumferential surface extending from and spaced apart along the inner diameter, having at least one opening through each inward extension configured to connect to a support ring;
the system further comprising a support ring wherein:
the support ring comprises: a flat, ring shape with a circumferential surface between an inner diameter and an outer diameter; and a plurality of connection notches opening into the circumferential surface from the outer diameter, spaced apart along the outer diameter, and configured to connect to the inward extensions of the top part or the bottom part.

20. The system of claim 16 further comprising an adapter ring wherein:
the top part further comprising a plurality of outward extensions of the circumferential surface extending from the outer diameter, spaced apart along the outer diameter aligned between the wire notches, having at least one opening through each outward extension configured to connect to an adapter ring;
the bottom part further comprising a plurality of outward extensions of the circumferential surface extending from the outer diameter, spaced apart along the outer diameter aligned between the wire notches, having at least one opening through each outward extension configured to connect to an adapter ring;
the system further comprising an adapter ring wherein:
the adapter ring comprises: a flat, ring shape with a circumferential surface between an inner diameter and an outer diameter; a first plurality of connection notches opening into the circumferential surface from the inner diameter, spaced apart along the inner diameter configured to connect to the outward extensions of the top part or the bottom part, a second plurality of connection notches opening into the circumferential surface from the outer diameter, spaced apart along the outer diameter, and configured to connect to the connection notches of the top part or the bottom part.
